(19) United States
(12) Patent Application Publication
(10) Pub. No.: US 2014/0372900 A1
(43) Pub. Date: Dec. 18, 2014

(54) METHOD AND DEVICE FOR CONTROLLING AT LEAST ONE POWER GENERATOR

(71) Applicant: SDMO Industries S.A.S. Co., Brest (FR)

(72) Inventor: Jean François de Sallier Dupin, Plouvien (FR)

(21) Appl. No.: 14/307,221

(22) Filed: Jun. 17, 2014

(30) Foreign Application Priority Data
Jun. 17, 2013 (FR) 13/55658

(51) Int. Cl. G06F 3/0484; G06F 3/0481; G06F 3/0488

(52) U.S. Cl. CPC G06F 3/0484; G06F 3/0488; G06F 3/0481
USPC 715/744

(57) ABSTRACT

A method and device for controlling at least one power generator implementing a touch-sensitive screen on which there selectively appears a set of command buttons available at a given point in time. The method includes determining a working context and selecting a set of command buttons available for said working context; displaying said set of available command buttons on said touch-sensitive screen; detecting an activation of one of the available command buttons, called an activated command button; and performing at least one action associated with said activated command button.

### FIELD OF THE INVENTION

The field of the invention is that of the controlling of power generators, and especially of isolated or “solo” power generators with or without source inverters, grouped together in “power plants”, possibly coupled with low-voltage or medium-voltage electricity distribution networks.

Such power plants can be installed especially in hospitals, banks, industrial buildings, data centers and centers for the production of raw materials (especially in the oil, gas and mining sectors).

### BACKGROUND

Power generators are classically commanded by the actuation of mechanical handles.

This means that anyone with access to the location of a power generator can access all the commands of the power generator, whatever his qualifications and/or level of authorization. In particular, he or she can have commands at their disposal which, if activated mistakenly or through lack of knowledge, could prove to be dangerous in certain states of the power generator. This can be all the more problematic for security since power generators are often situated outdoors and therefore have access-securing means that are often weaker than such means used with respect to power generators used indoors.

In addition, the tracking of one or more generators is generally complex. The values of the different working parameters of the generator are often accessible only locally, for example through a multitude of dials situated on the front face of the apparatus. Certain pieces of information, especially the timelines and evolution of the parameters, are not available or need to undergo independent processing operations. Besides, when a power plant has several generators, potentially distant from one another, it is difficult to track the different generators simultaneously.

Over and above the problem of tracking, the control of such generators is generally a complex operation requiring in-depth knowledge and training. Moreover, these operations are often still not obvious, even to a trained operator, and are not ergonomical.

Thus, one drawback of the prior art is that most of the control or maintenance operations require a visit by a technician and therefore, sometimes, relatively lengthy interruptions in service.

Yet another difficulty of the prior art is the complexity of programming of a generator or power plant. It has already been proposed, for such programming, to use the “Ladder” computer language (registered mark) which is used to control electrical circuits. This language makes it possible to develop a program and then compile it to a computer and then transfer it to a control unit of the generator.

However, this language is relatively complex in its current form and use. In practice, this approach is cumbersome to implement because it is rare for the compiled program to be directly functional on the control unit of the generator. This means that there are several to-and-fro motions, between the programming and the execution, entailing searches for causes of malfunction or error that require action by specialists and which, again, can disturb or even interrupt the service.

Other aspects of the invention will become apparent by consideration of the detailed description and accompanying drawings.

### SUMMARY OF THE INVENTION

Embodiments of the invention are aimed especially at overcoming at least certain of these prior-art drawbacks.

Thus, it is a goal of at least one embodiment to simplify and secure the implementation and use of a power generator or of a power plant comprising several power generators.

It is another goal of at least one embodiment to facilitate the controlling, maintenance and/or programming of a power generator or a power plant for at least one of the different acting parties.

It is yet another goal of at least one embodiment to take better account of the constraints related to the particular field of the invention, for example practical constraints related to the implantation of power generators, especially their place of implantation which is often outdoors, or constraints related to the qualification of the acting parties.

Embodiments of the invention pertain to a method for controlling at least one power generator.

According to one embodiment of the invention, a method implements a touch-sensitive screen on which there selectively appears a set of command buttons available at a given point in time, said method implementing the following steps:

determining a working context and selecting a set of command buttons available for said working context;

displaying said set of available command buttons on said touch-sensitive screen;

detecting an activation of one of the available command buttons, called an activated command button; and

performing at least one action associated with said activated command button.

In certain embodiments, all the commands possible on a power generator are accessible through the touch-sensitive screen. Such embodiments offer the advantage of providing better ergonomy to a user since he is not disturbed by the use of a different control means, in terms of subject knowledge and sensitivity especially.

According to one particular characteristic of an embodiment of the invention, the method of control comprises a step for managing a selector displayed on said screen enabling the selection of a mode of working of said power generator from among at least the following four modes:

a mode called a “not-in-service” mode;

a manual working mode;

an automatic or “auto” working mode;

a “test” working mode,

and a step for managing an on/off switch displayed on said screen, said switch being active only in the “manual” mode and proposing only the “On” possibility if said power generator is off and only the “Off” possibility if said power generator is on.

Thus, embodiments of the invention offer the advantage of proposing to a user only commands that he is permitted to actuate. The commands proposed may especially depend on the mode of operation and on the configuration in which the power generator is situated.

Such an embodiment also enables the user to be guided in his actions and therefore to be reassured.

According to one particular characteristic of an embodiment of the invention, the method for controlling comprises a step for managing the state of at least one element for the cutting off and protection of said power generator.

Thus, embodiments of the invention enable an acting party to take action locally or remotely to guarantee the security of a power generator.

According to one particular characteristic of an embodiment of the invention, said step for detecting an activation of one said available command buttons comprises the following sub-steps for at least certain buttons and/or certain working contexts:

detecting a touch-sensitive contact on a zone of said touch-sensitive screen on which one of said command buttons is displayed;

if the touch-sensitive contact is shifted outside said zone by means of a sliding movement on the surface of the screen, no action associated with said button is performed;

if the touch-sensitive contact is released, a time-out is initiated for a predetermined duration;

if a new touch-sensitive contact occurs before the end of said time-out, no action associated with said button is performed; and

if no new touch-sensitive contact occurs before the end of said time-out, said action or actions associated with said button are performed.

Thus, embodiments of the invention make it possible to take account of a possible error in handling by the user by giving him a period of time to correct the selection made. Indeed, since power generators are often situated outdoors, personnel in charge of handling operations often have to work with gloves to protect themselves against the cold. This makes it sometimes difficult to designate a portion of the screen with precision. The features of embodiments of the invention prevent undesired selection.

According to particular features of embodiments of the invention, the predetermined duration of a time-out varies as a function of the button considered and/or the working context.

Thus, the duration of the initiated time-out can be different depending on the selection made and/or the current working mode of the power generator. For example, in certain embodiments, the commands of the power generator, especially the most critically important ones, could have a time-out duration that is lengthier than that applied for simple changes in pages to be displayed, so as to leave the acting party more time to correct his action if need be. On the contrary, in other embodiments, which may be complementary ones, certain commands, especially commands that could be urgent, for example an emergency stop command or a passage into “not-in-service” mode could be activated with a very brief time-out or a zero time-out to boost the reaction speed of the method of control.

According to one particular characteristic of an embodiment of the invention, the step for initiating a time-out comprises an alerting sub-step upon the activation of said action associated with said button.

Such an embodiment of the invention informs the user visually or by sound, for example, by a ringing sound or by voice synthesis, of the selection taken into account, which will be effective unless there is an order to the contrary on the user's part so that, firstly, the user is certain of having actually made a selection (since the reaction of the control device is not immediate) and so that, secondly, if there are handling mistakes, the user will perceive this more easily.

According to one particular embodiment of the invention, the method of control provides for the display on said touch-sensitive screen of:

at least one summary page presenting mechanical and/or electrical information on at least one power generator in an illustrated form;

at least one detailed page, accessible from said summary page, by touch pressure on a zone of the touch-sensitive screen bearing the illustration associated with the information for which a summary is required;

at least one timeline page displaying at least one curve of the evolution in time of the magnitude of a value relative to said piece of information; and

at least one predetermined pressure zone on said touch-sensitive screen enabling a return to a previous page at each instant.

Depending on the embodiments and the working context, these pages can enable a display and/or action on at least one power generator.

According to one particular embodiment of the invention, the method of control comprises a screen and/or video capture command and a step for transmission and/or storage on an external data carrier of said capture.

Thus, embodiments of the invention make it possible to carry out screen and/or video captures which can be saved on an external storage means for example a USB stick or a memory card and/or sent by email to a third party, especially for the purpose of maintenance, training or documentation or for business reasons, related for example to invoicing.

Thus, embodiments of the invention improve the diagnosis of malfunctions and make the analysis of the working data more precise.

According to one particular embodiment of the invention, the method of control comprises a command for capturing a sequence of commands and corresponding pieces of information displayed on said touch-sensitive screen and a step for the transmission and/or storage of said capture on an external data carrier.

Thus, in certain embodiments, the invention enables especially storage of certain command sequences, for example with a view to traceability and enables these sequences to be replayed more easily thereafter.

According to one particular embodiment of the invention, the method of control comprises the following steps:

detecting a fault of working of said power generator; and

generating an alert representing said fault on said touch-sensitive screen.

According to one particular characteristic of an embodiment of the invention, the method of control further comprises a step for executing an emergency protocol.

Thus, embodiments of the invention enable the processing of an alarm in causing the disappearance of a fault or by acting on the operation of a power generator to cope with the consequences of this fault.

According to one particular characteristic of an embodiment of the invention, said step for determining a working context takes account of the current working mode and of at least one of the information elements belonging to the group comprising:

a level of authorization of the current user;

a level of browsing in the different displayable pages on said touch-sensitive screen;

an occurrence of at least one working malfunction; and

an acknowledgement of at least one alert relative to a fault of working.

According to one particular embodiment of the invention, the method of control comprises the following steps:

displaying, on said screen, of a representation of at least two networking power generators;

selecting one of said power generators by tactile pressure on the corresponding representation;

displaying information on said selected power generator; and

controlling of said selected power generator, as a function of tactile pressure on the corresponding command buttons.

According to one particular embodiment of the invention, the method of control comprises a step for transferring data intended for display on said touch-sensitive screen to a tablet and/or a touch-sensitive telephone and a step for receiving commands, as a function of tactile pressure picked up by said tablet and/or said telephone.

Thus, certain embodiments of the invention enable the control device of the invention to be at least partially conducted from a third-party device.

According to one particular characteristic of an embodiment of the invention, the method of control comprises a step for programming the electrical behavior of said power generator or generators.

According to one particular characteristic of an embodiment of the invention, said programming step implements a graphic representation of an electrical network comprising the power generator or generators, modifiable through said touch-sensitive screen.

According to one particular characteristic of an embodiment of the invention, said graphic representation implements a color representation, distinct colors being assigned in real time to each element of the electric circuit, depending on whether the electric current flows or does not flow within this circuit.

Thus, through a graphic representation close to that usually adopted for representing electrical diagrams, embodiments of the invention make it easier for by acting parties technically qualified in the field of electricity to take charge of the control device.

According to one particular characteristic of an embodiment of the invention, said programming step comprises a step of compilation and a step of execution of a program performed by an acting party, said steps of compilation and execution being carried out by a same control unit.

According to one particular characteristic of an embodiment of the invention, said programming step implements the “Ladder” (registered mark) programming language.

Such programming modes offer the advantage of enabling the programming of the man/machine interface of the device locally, hence without requiring additional means. In addition, they make it possible to avert certain difficulties related to the use of different computers for generating and using executable libraries, especially a necessity of porting libraries when these computers do not work with the same operating system, the programming modes also make it possible to prevent substantial waiting times before the use of a new library, because for example of the characteristics of transmission between these computers (transmission flow rate, network cut-off etc.).

According to one particular characteristic of embodiments of the invention, said programming step comprises a step for the reading, by voice synthesis, of all or part of a program so as to enable its remote analysis and/or a step for receiving and transcribing voice instructions.

According to another aspect, embodiments of the invention also pertain to a device for controlling at least one power generator.

According to embodiments of the invention, the control device comprises a touch-sensitive screen on which there selectively appears a set of command buttons available at a given point in time, and means for driving said touch-sensitive screen, comprising:

means for determining a working context and selecting a set of command buttons available for said working context;

means for controlling the display on said touch-sensitive screen of said set of available command buttons;

means for detecting an activation of one of said available command buttons, called an activated command button; and

means for launching at least one action associated with said activated command button.

Finally, embodiments of the invention also pertain to a power generator comprising control means.

According to embodiments of the invention, the power generator comprises a touch-sensitive screen on which there selectively appears a set of command buttons available at a given point in time, and means for driving said touch-sensitive screen, comprising:

means for determining a working context and selecting a set of available command buttons for said working context;

means for controlling the display on said touch-sensitive screen of said set of available command buttons;

means for detecting an activation of one of said available command buttons, called an activated command button; and

means for launching at least one action associated with said activated command button.

### BRIEF DESCRIPTION OF THE DRAWINGS

Other features and advantages of embodiments the invention shall become more apparent from the following description, given by way of a simple illustrative and non-exhaustive example and from the appended drawings:

FIG. 1 illustrates an example of an architecture of a control device according to an embodiment of the invention.

FIG. 2A illustrates an example of a summary page related to an isolated or solo power generator in “Manual” working mode and in a “Standby” working state.

FIG. 2B illustrates an example of a summary page pertaining to a particular power generator of a power plant, in “Auto” working mode and in a “Production” working state.

FIG. 2C illustrates an example of a summary page pertaining to the selection of a power generator in a power plant.

FIG. 2D illustrates an example of a summary page pertaining to a particular power generator of a power plant, in a “Production” working state with an indication of a sound alarm.

FIG. 2E illustrates an example of a detailed page relating to a particular power generator of a power plant in a “Production” working state.

FIG. 2F illustrates an example of a detailed page presenting a temperature curve relative to the power generator of FIG. 2E.

FIG. 2G illustrates an example of a detailed page presenting measurements for a power generator in “Manual” working mode and in an “Unavailable” working state.

FIG. 3 illustrates the dynamic operation of the method of an embodiment of the invention during the first start of the control device in a particular embodiment.

FIG. 4A illustrates the dynamic operation of the method of an embodiment of the invention during a power grid cut-off.

FIG. 4B illustrates another example of a summary page pertaining to a particular power generator of a power plant in “Auto” working mode and in “Production” working state.

FIG. 5A illustrates the dynamic working of the method of an embodiment of the invention during an appearance of an alarm.

FIG. 5B illustrates an example of a summary page pertaining to a particular power generator of a power plant, after the appearance of a fault.

FIG. 6 illustrates the step of programming of the method of an embodiment of the invention in one particular embodiment.

FIG. 7 illustrates the step of animation of a graphic object of the method of an embodiment of the invention in one particular embodiment.

FIG. 8 illustrates an example of representation by “Ladder” diagram of a graphic object.

FIG. 9 illustrates a first example of simulation of the right-hand click on a touch-sensitive screen for the “Ladder” programming of a graphic object.

FIG. 10 illustrates an example of a literal “Ladder” representation of a graphic object.

FIG. 11 schematically illustrates an electronic card of a module of the device according to an embodiment of the invention.

FIG. 12 illustrates a second example of simulation of a right-hand click on a touch-sensitive screen for the “Ladder” programming of a graphic object.

### DETAILED DESCRIPTION

### 1 Accessibility to the Control and Command Elements

A first aspect of embodiments of the invention consists in offering a person taking action on a power generator, either directly or from a power plant to which this power generator is attached, appropriate (limited or extended) possibilities of controlling the power generator. This is done by proposing only actions that are possible for this acting party, firstly on the basis of a working context of the power generator, especially the current working mode and/or current operational state of the power generator, and secondly on the basis of the acting party's authorization profile.

### 2 Architecture of a Control Device

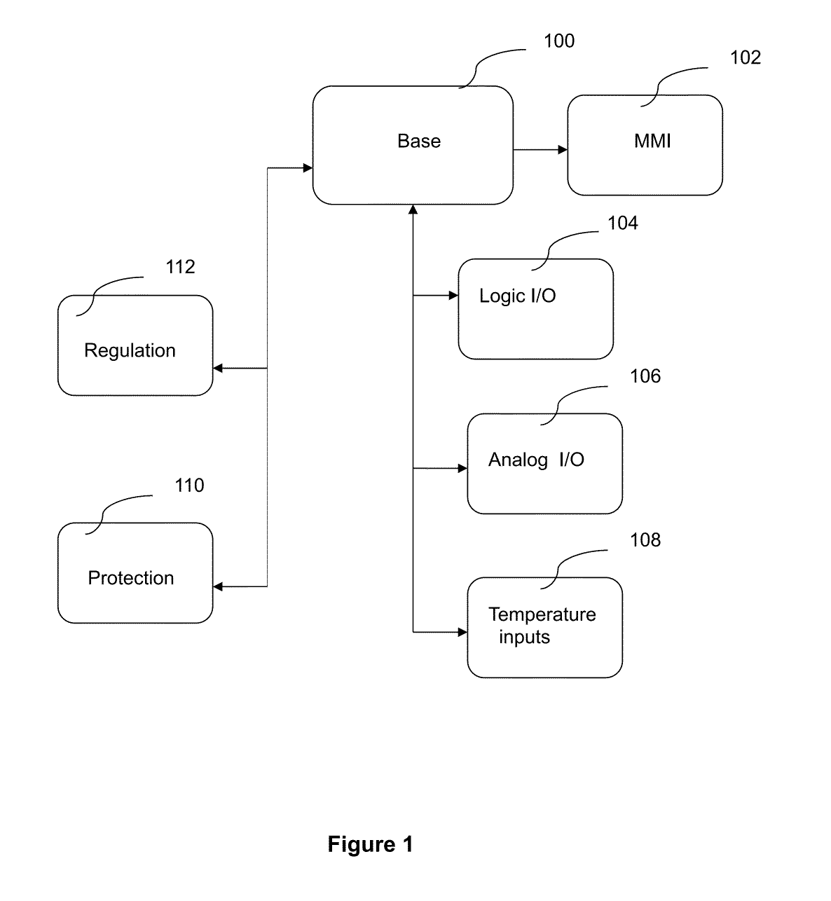

Referring to FIG. 1, we present an example of architecture of a control device of at least one power generator according to the invention according to one particular embodiment.

Depending on the embodiments of the invention, the control device can enable the command, the control, the regulation and/or the protection of one or more power generators according to numerous configurations.

The configurations extend from the isolated power generator (known as the “solo” generator) with or without source inverter, to power generators coupled to one another, making it possible to set up power plants which themselves can be coupled to one or more low voltage (LV) or medium voltage (MV) power grids.

Such a control device can especially be installed on an independent control panel (for example an S9100 control panel commercially distributed by the Applicant), in a casing accessible on at least one face of a power generator, or on a cabinet dedicated to the management of a set of power generators (or power plants), for example the “Iroise” cabinet commercially distributed by the Applicant.

2.1 Modules of the control device.

In the embodiment illustrated, the control device drives or controls at least one power generator. It comprises several modules, including one base module 100 for electronic measurements and automation, especially a module at least partially implementing the automaton programming standard IEC61131-3, for example the base module “X208” by the present Applicant, a man/machine interface module 102 and a regulation module 112.

In certain embodiments, as in the embodiment illustrated, the control device can also comprise logic input/output management modules 104, analog input/output management modules 106, temperature acquisition modules 108 and cut-off and protection modules 110, for example for commanding circuit-breakers. These modules are, however, optional.

Depending on the embodiments, the invention is implemented by means of software and/or hardware components. From this viewpoint, the term “component” can correspond in this document to a software component, to a hardware component, or to a set of hardware and software components.

A software component corresponds to one or more computer programs, one or more sub-programs of a program or more generally to any element of a program or an item of software capable of implementing a function or a set of functions according to what is described here below for the modules concerned. A software component of this kind is executed by a data processor of a physical entity (for example an electronic board, an integrated circuit, a smartcard, a memory card, an electronic board) and is capable of accessing the hardware resources of this physical entity (memories, recording media, communications buses, input/output electronic boards, user interfaces, etc.).

Similarly, a hardware component corresponds to any element of a hardware assembly capable of implementing a function or a set of functions for the module concerned. It may be a programmable hardware component or a component with an integrated processor for executing software, for example an integrated circuit, a smartcard, a memory card, an electronic board for executing firmware, etc.

In the embodiment illustrated, the modules of the control device, especially the man/machine interface module and the base module, are constituted by electronic boards.

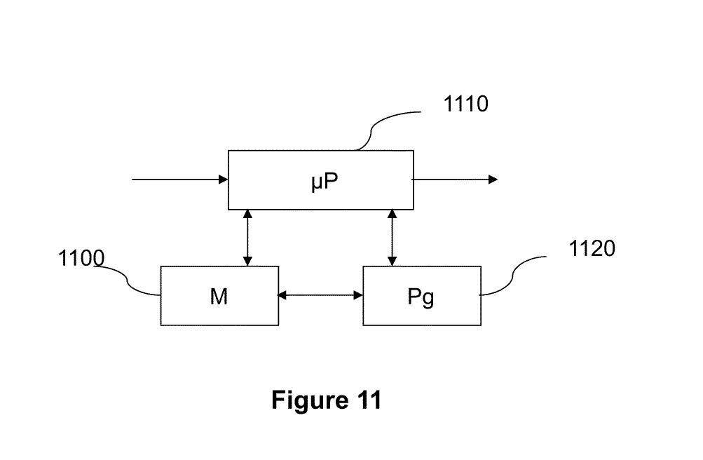

Referring to FIG. 11, the simplified structure is presented of an electronic board of this kind according to the invention.

An electronic board comprises a memory 1100 comprising a buffer memory, a processing unit 1110 equipped for example with a microprocessor (μP), and driven by a computer program 1120, the execution of which implements at least a part of the method for controlling according to one of the particular embodiments of the invention.

At initialization, the instructions of the computer program product 1120 are for example loaded into a RAM and then executed by the processor of the processing unit 1110.

The processing unit 1110 inputs a header of a data stream.

The microprocessor of the processing unit 1110 implements certain steps of the method of control described here above according to the instructions of a computer program 1120.

To this end, the electronic board comprises, in addition to the buffer memory 1100, the means needed to implement the method of control of the invention.

These means are driven by the microprocessor of the processing unit 1110.

### 2.2 Man/Machine Interface.

According to embodiments of the invention, the man/machine interface (MMI) comprises at least one touch-sensitive screen, making it possible to drive at least one power generator. It can indeed be a man/machine interface situated on an isolated power generator and enabling the control of the power generator. It can also be a man/machine interface relative to at least one power generator of a power plant. According to the embodiment described here below, the same MMI makes it possible, depending on the different configurations, to provide both these aspects, depending on the installations. The MMI can, therefore, be parameterized to be adapted to a given configuration.

This screen can for example be placed on one of the power generators of the power plant or another apparatus, for example a dedicated apparatus, referred to in the remaining part of this patent application as a “Common Part”. It can be used to control the power generator in which it is situated, and, if necessary, to control the other power generators of the power plant.

The touch-sensitive screen is preferably adapted to the working conditions of the power generator. Indeed, a power generator is sometimes used outdoors, or in particular surroundings (temperature, dust etc.) and this implies constraints on the equipment used. Thus, the touch-sensitive screen must be capable of being used in very bright sunlight. It should be capable of being resistant to dust and/or to weather vagaries, and for example it should comply with the IP65 standard on ingress protection.

It must also be resistant for example to fouling and impacts and should not be excessively reactive. For example, a hit by a bird settling on the screen should not be mistaken for action by an acting party. The screen must also be adapted to use by people who might work on a power generator and are working outdoors, for example a person standing upright, or wearing gloves. This involves constraints in terms of screen size and sensitivity, as acting parties sometimes have difficulty in modulating the strength of the pressure they apply to the screen.

### 3 Static Description of the Control Device.

The different view pages enable the command, control, regulation and protection of one or more power generators. They differ according to the configurations of the power generators implemented. Herein, the term “Page” designates the image rendered by the screen (or an essential part of this image) presenting the different information and control elements.

The pages comprise especially a utilization page or a “conduct-of-operations” page which is displayed by default and can be used to view the state of at least one power generator.

Such a page makes it possible especially to obtain knowledge of:

the state of the power generator (operation, electrical measurements and mechanical measurements, alarms, faults);

the state of a power grid (power grid presence, electrical measurements);

the state of an electrical power plant (electrical measurements);

the state of the cut-off modules and/or protection modules;

the state of the regulation and protection modules;

the state of the inputs/logic services; and/or

the mode and working state of a generator.

To facilitate reading and interpretation, these different pieces of information can be rendered in a usual and classic form, for example by an illustration of an analog dial.

Other pages can be accessed according to the working context of the power generators, especially the acting party's profile, the commands actuated and the working state and/or working mode of the power generators.

For example, when a power generator is on standby, it is possible to view a page giving a glimpse into data related to the pre-heating of the power generator, temperatures, oil levels, etc. Pressure on the touch-sensitive screen area rendering a graphic representation of the engine of the power generator will show a page giving precise mechanical information on the engine, in the standby state of the power generator.

In the case of a control device for controlling a set of power generators working as a power plant, a first page gives a general view of the power plant, comprising summary information on each power generator, for example its state and its working mode.

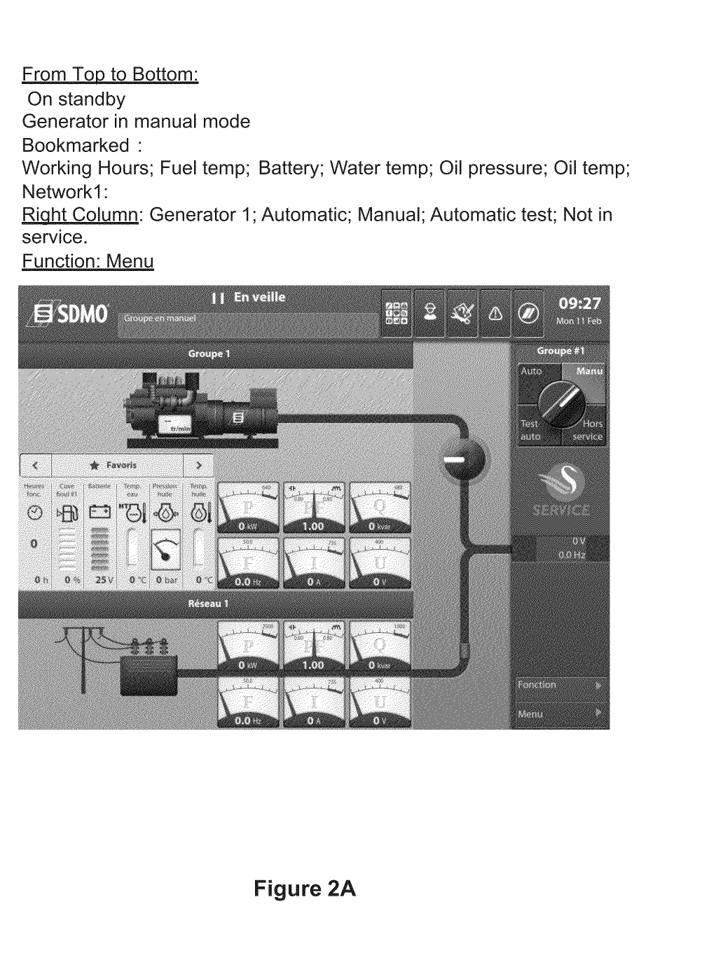

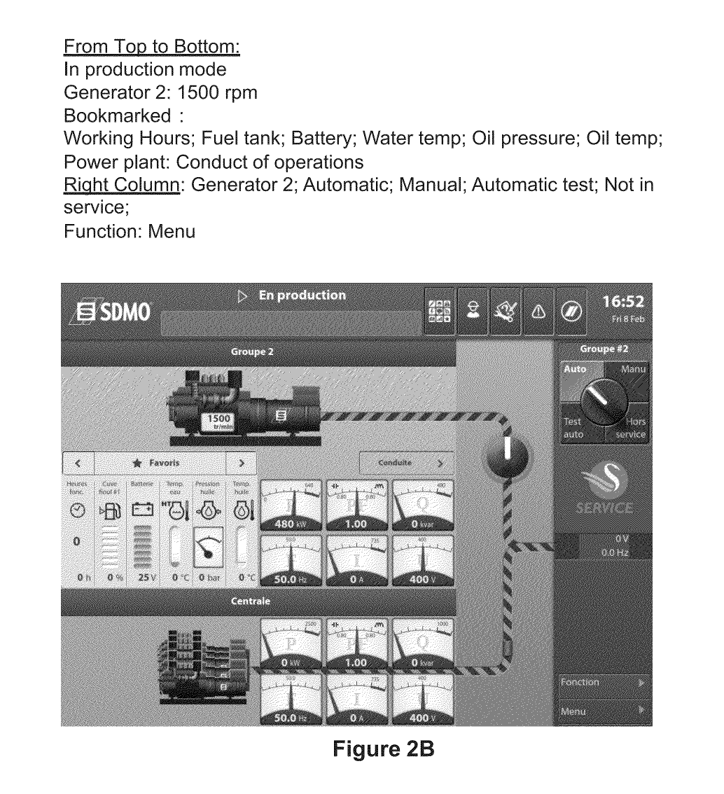

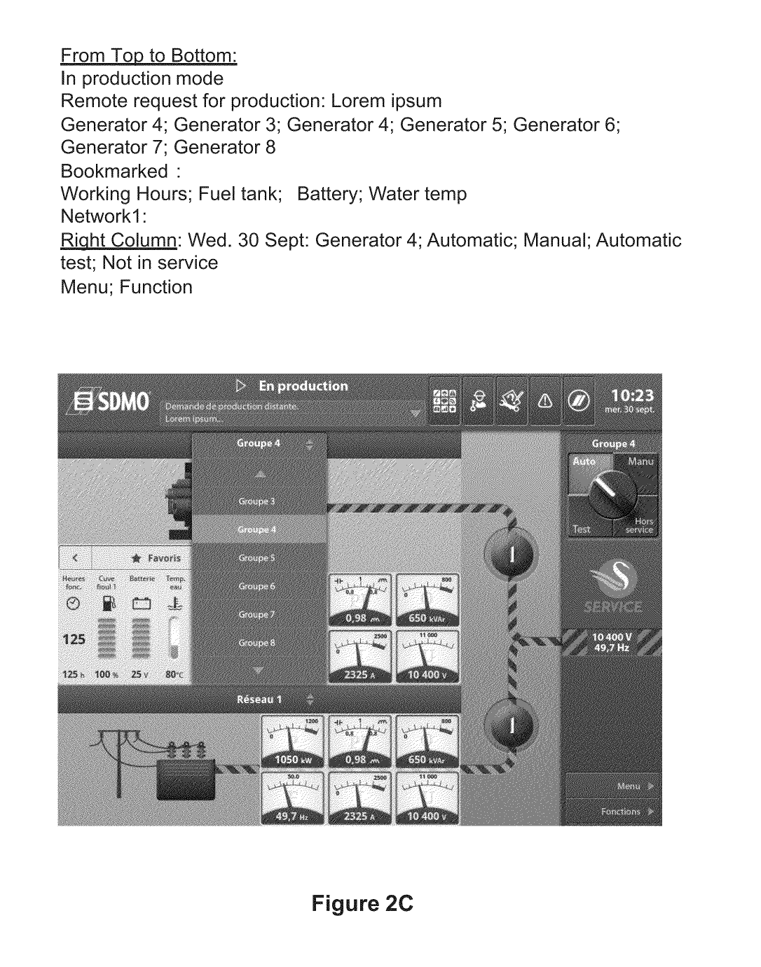

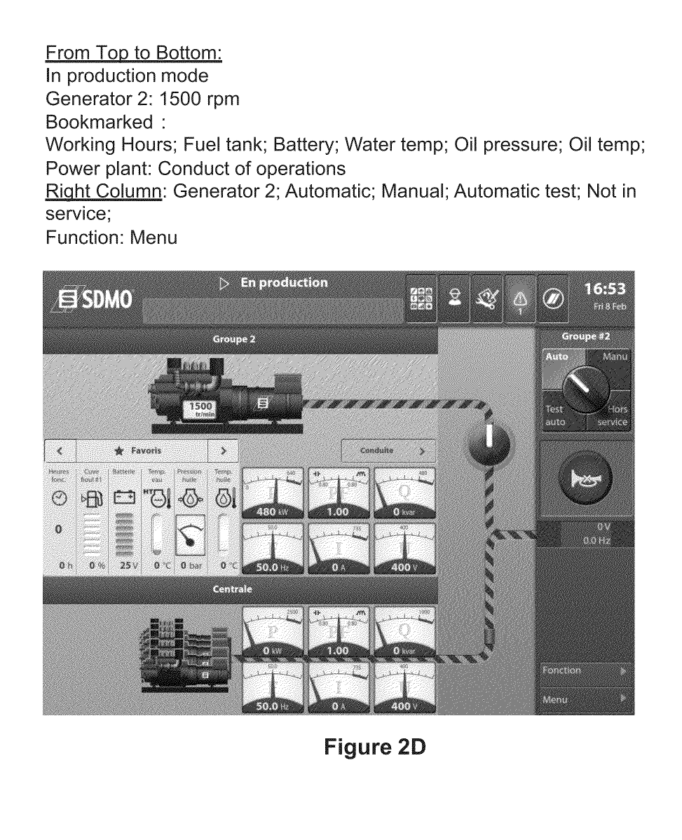

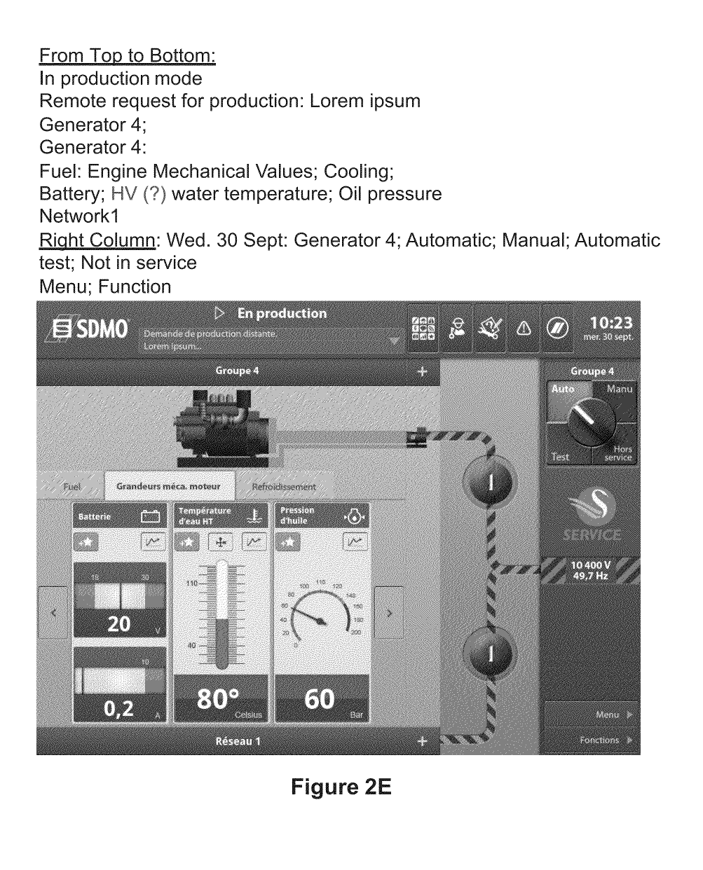

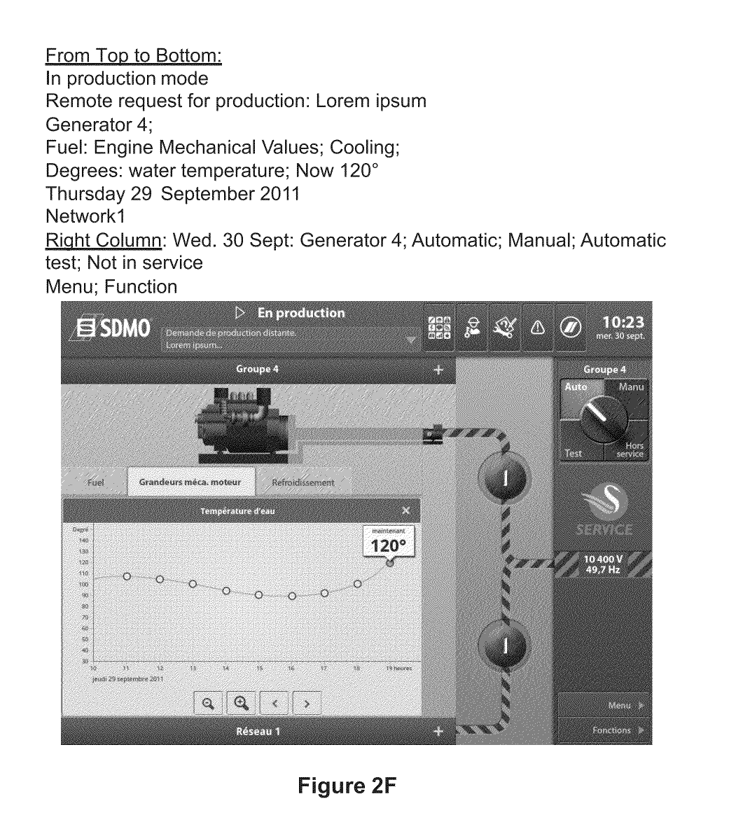

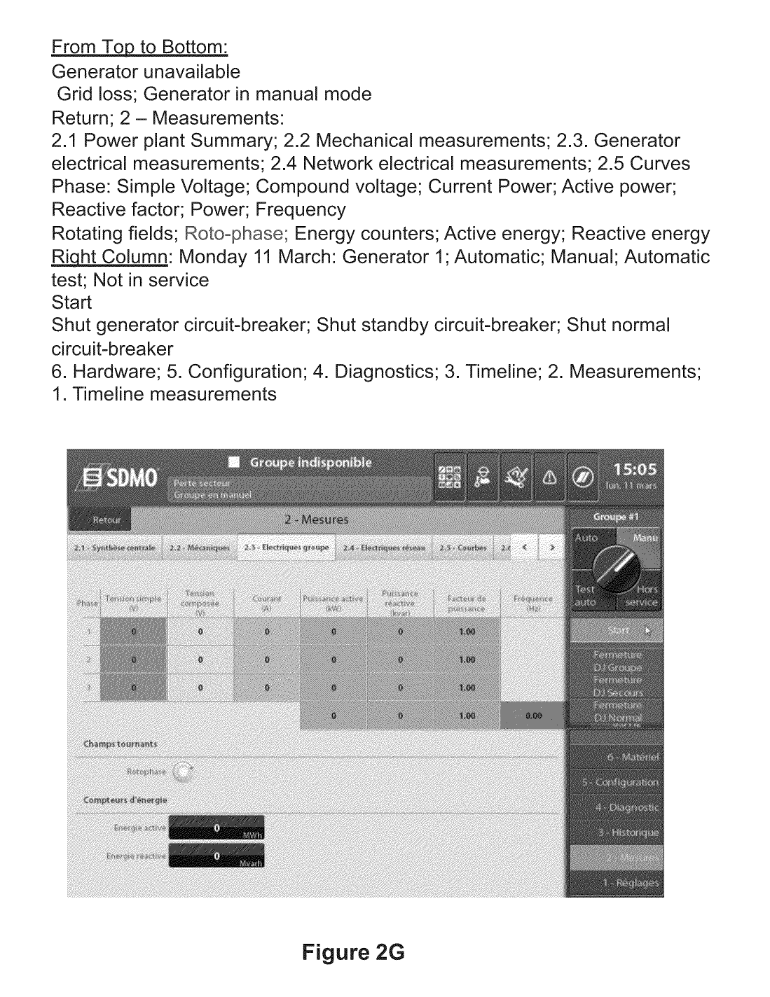

The selection of a power generator, as illustrated in FIG. 2C, makes it possible to obtain fuller information, especially dynamic information such as a level of fuel, oil, coolant liquid or a temperature of water or oil as illustrated in FIG. 2D. It is also possible for the acting party to select the information that he wishes to view (for example an active or reactive power, a phase-to-neutral or phase-to-phase voltage, a battery voltage or battery charge, a current, a frequency, a<<cos φ value, a power factor value, an engine speed, etc.).

Certain pieces of information can be viewed in different forms giving access to their current value or to their evolution in time. Thus, FIGS. 2E and 2F present two different views of the water temperature of a power generator.

A “diagnostics” page can also give access to all of variables of the control device, the state of the (logic or analog) inputs/outputs, the internal variables of the regulation and protection modules, the mechanical variables, the variables linked to a programming of the graphic interface, especially by “Ladder” type programming.

In the embodiment illustrated, four pages at most are necessary to determine the configuration of the installation.

FIGS. 2A to 2G and 4B and 5B give examples of representation of such pages in different configurations.

### 3.1 View Pages.

A view page can be subdivided into several view zones, each carrying different pieces of information. A description is given here below, with reference to FIGS. 2A to 2G and FIGS. 4B and 5B, of an example of composition of a view page in one particular embodiment of the invention.

### 3.1.1 Structure of a View Page.

In the embodiment illustrated, a view page is formed by several view zones. Certain zones, such as the descriptive screen band, can be seen in all the pages while others, such as the network zone in the conduct-of-operations or utilization page, can be particular to certain pages.

### Descriptive Screen Band.

In the embodiment illustrated, the descriptive screen band (also called the “screen upper band”) is divided into several parts.

Thus:

a first part of the screen band enables a return to the “utilization” page;

a second part is used to view the working state of the power generator (off, on standby, in production, malfunctioning etc.) and contains, as the case may be, other indications reporting events and/or actions performed on the generator or on an element of the generator (for example a starting order, a return to the power grid, a cooling of the power generator, etc.),

a third part enables browsing in the accessible functions (view and/or command pages, acting party identification page, alarm management pages, etc.), or the modification of the display of the data presented (date, time, unit of measurement of magnitudes of mechanical values for example), and

a fourth part can contain general information (date and/or time, connection time, etc.).

In certain embodiments, the screen upper band is present in all the pages.

### “Power Generator” Summary Zone.

In the embodiment presented, this zone is present, or active, only when the device takes charge of a single power generator or after selection, in a Common Part, of a power generator of a power plant.

This zone gives an overall summary view of the state of the power generator (display of magnitudes of electrical and mechanical values, the state of the alternator and a power connection) and as the case may be, depending on the acting party's profile and the working mode especially, the starting or stopping of the power generator for example by a dedicated button (“Engine START” or “Engine STOP”).

### “Power Plant” Summary Zone.

In the embodiment presented, this zone is represented only when the device takes charge of the Common Part of a power plant. It makes it possible to obtain a summary view of the power plant and comprises for example a representation of a power connection, indications of certain physical characteristics of the power plant (such as especially a total number of power generators, number of power generators in used or available, magnitudes of electrical values of the power generators, etc.).

### “Network” Summary Zone.

Depending on the embodiments, this zone can be represented when the device takes charge of the Common Part of a power plant, on a same page as a “power plant zone” or a “power generator zone” after selection of a power generator of a power plant or when the device takes charge of a single power generator at the same time as a “power generator” summary zone.

It makes it possible to obtain a summary view of the network and comprises for example a representation of a power connection, indications of magnitudes of electrical values.

### Screen Band for the Cut-Off and Protection Module.

The screen band of the cut-off and protection module (for example circuit-breakers) represents a part of the electrical installation situated downstream from the driven power generator and/or the power plant and/or a power-grid transformer. In the embodiment presented, it comprises a command button for each circuit breaker (especially for the circuit-breaker of the power generator and for the circuit-breaker of the power-grid). In the embodiment illustrated, these buttons can be actuated (and are therefore visible) only in the “manual” working mode.

When a power generator is in utilization mode, especially in production state, the screen band for the cut-off and protection module is generally visible on the conduct-of-operations page of the generator.

### Command Screen Band.

The command screen band makes it possible especially to select the working mode of the power generator. In the embodiment illustrated, this selection is implemented by means of a touch sensitive selector associated with several keys.

In particular, the current working mode can be indicated visually, for example by a different color of the key selected or the position of the switch.

In certain embodiments, the command screen band can also provide complementary indications such as a voltage value or a frequency.

Finally, the command screen band can enable access to special commands according to the working context of at least one power generator represented, especially the acting party's profile, actuated commands and the working state and/or working mode of the power generators.

For example, in the illustrated embodiment (see FIG. 2A), the command screen band comprises a “Function” key giving access to programmed commands specific to the control device and a “Menu” key giving access, according to the acting party's profile, to:

the adjustments needed for any running of the power generator or the power plant (for example instructed electrical values defined on the network side, power plant side or power generator side, power thresholds, thresholds for starting and stopping the power generators of a power plant, network parameters, time-outs, auxiliary parameters);

the complete viewing of all the mechanical or electrical measurements of at least one power generator and/or at least one electrical network, for example a low-voltage or high-voltage network;

viewing the timeline of all the magnitudes of electrical and mechanical values;

diagnostics of the state of any logic input and output, analog input, system input;

the full configuration of the device (application, regulation, protection);

the viewing of the physical architecture of the controlled installation (electrical power unit, input/output cabinets, CAN bus, series links, etc.).

FIG. 2G presents an example of measurements proposed in one particular embodiment. In the particular case illustrated, it is thus possible to obtain a summary relating to the power plant, the mechanical measurements, electrical measurements (of a power generator or of the network for example), curves of evolution, harmonics, etc.

In certain embodiments, the control screen band remains always visible.

### 3.1.2 Rules of Viewing.

In certain embodiments, a graphic chart can be used to facilitate understanding by an acting party.

For example, the hardware components can be represented in a form close to reality (see for example the representation of the “START” button or that of the working mode selector or again the symbolic representation of a power generator, a power plant or a network in FIGS. 2A to 2F, 4A and 5B.

Moreover, logic symbols or symbols taken from the field of electricity can also be used. Certain embodiments especially implement an interface based on the “Ladder” (registered mark) language.

Color codes can also be used. Thus, a first color (such as grey) can be used to symbolize an absence of activity or an unknown state of an element, and a second color (such as blue) can be used to represent an active element.

For example, in certain embodiments, a loss of connection between the control device and one of the remote-controlled power generators can make it temporarily impossible to view and/or command the working mode of a remote power generator. In this case, the message “No Connection” can for example be displayed in the screen upper band while the selector of the working modes disappears and the four indications of the working mode are grey.

### 3.1.3 Example of a Cut-Off and Protection Module Screen Band.

According to the embodiment shown, the screen band of the cut off and protection module gives access to the state and to the commanding of several circuit-breakers. A button is associated with each circuit-breaker. These are linked by conduits each symbolizing an electrical line.

Each button has three functions: viewing the state of the circuit-breaker in the form of an interrupter, open or closed, enabling a command of the activation or deactivation of the circuit-breaker.

Accessibility to the command buttons is linked to the working context of the power generator and the profile of the acting party who accesses the touch-sensitive screen. In certain embodiments, the actuation of a button can be confirmed visually or by sound, for example during a short instant, to signify the taking into account of an acting party's action.

For example, in the embodiment presented, a button is commonly represented in a first color (such as grey) while a second color (such as blue) is used during its actuation.

When a voltage is present upstream from a circuit-breaker, the electrical line symbolized by a conduit passes in the embodiment presented from “grey” to hashed “grey/blue”.

When there is a flow of current in the circuit-breaker, the “grey/blue” conduit is animated in a scrolling motion.

The logic of animation of the conduits according to their state is governed by means of a specific programming.

### 3.1.4 Mechanism for Activating Keys.

In certain embodiments, the mechanism for activating a key makes it possible to take account of possible errors of handling by an acting party. Indeed, owing to the sensitive character of the handling operations performed, it is necessary to ensure that the action implemented is truly the action desired by the acting party. What has to be done therefore is firstly to enable the acting party to change his mind and secondly to present the action that has just been actuated so that he can correct his action.

Thus, the step for detecting an activation of a command button can comprise the following sub-steps:

detecting a touch-sensitive contact on a particular zone of the touch-sensitive screen, called a “activation zone” of the button, for example a zone centered on the button and covering at least the graphic representation of the button;

if the touch-sensitive contact moves outside the activation zone of the button, through sliding and without a relaxing of the pressure applied by the acting party, the activation of the button is not taken into account;

if, on the contrary, the pressure is relaxed in the activation zone, a time-out is initiated at the end of which the action designated by the button is performed, unless another pressure on the touch-sensitive screen takes place (in the zone of activation of the button for example, or in a zone of activation of another button or at any unspecified part of the touch-sensitive zone, depending on the embodiments of the invention).

The duration of the time-out can vary according to the working context of the power generator or according to the activated button.

In certain embodiments, the current state of a command button can be represented in a first bright color (green for example), the actuated state being represented by a second bright color (red for example), and the other possible states (neither current not selected) of the button being represented by a neutral color (for example grey).

### 3.1.5 “Pop-Up” Windows.

In certain particular embodiments, “pop-up” windows can be presented to the user for example during an appearance of a fault or for the providing of informational messages such as help messages.

In other embodiments on the contrary, a pop-up window is never presented to the acting party by the control device. Such embodiments have the advantage of never disturbing an acting party by an untimely display or by concealing from him information that he wishes to access.

### 3.2 Other Pages Proposed.

In certain embodiments of the invention, in addition to the pages for viewing and modifying a working context of at least one “power generator”, the method of control enables access to other particular pages, such as pages for configuring the device and/or pages for generating and/or consulting a timeline.

### 3.2.1 Configuration.

Thus, for example, the method can comprise a step of preliminary configuration of the device with a view especially to parameterizing the type of installation (“solo” generator, power plant with or without Common Part), a number of monitored power generators, their identification, a management of sources, a number of circuit-breakers on the network side, a number of networks coupled to a power plant, a mode of command of a circuit-breaker of a power generator (without command, manual command or automatic, etc.), a voltage domain (high voltage or low voltage) and/or a mode of coupling a power generator or a power plant (without coupling, presence of a normal/emergency inverter, temporary coupling or permanent coupling to the grid, in production, etc.).

### 3.2.2 Recording or Printing.

In certain particular embodiments, possibly complementary ones, the method of control makes it possible to preserve data representing a working context of at least one power generator.

For example, the method can comprise a screen capture step to retain a visualized page and/or a step for retaining a sequence of visualized pages and/or a step for retaining at least the working context of at least one generator.

It can also comprise steps for printing and/or saving retained data in electronic format, for example by means of an external storage medium such as a USB key and/or a detachable hard disk drive and/or a transfer of data to a third-party device such as a tablet or a remote computer. These steps can for example be implemented after activation of an “Export” button proposed in certain pages.

This enables a user who wishes to preserve a view of the current situation and/or be able to transmit it, for example to a specialist, for information or analysis, to automatically store a current view of the screen display. As a complement, it can be planned to have a continuous recording of a sequence of pages with the associated commands and measurements to enable a more precise analysis. Classic symbols such as a camera and a video camera can be used to control these recordings.

In this case, a USB port or another adapted port is preferably placed in proximity to the touch-sensitive screen. A wireless transmission, for example by WiFi, is also possible.

### 3.2.3 Timeline.

The method can also enable access to particular view pages for viewing preserved data, for example by means of a “Timeline” button proposed in certain pages.

For example, in certain embodiments, it is possible to access a detailed page on certain particular pieces of information and/or a timeline page displaying for example, in text or graphic form for example (for example curves, lists or tables), changes over time in the magnitude of the value corresponding to at least one piece of information. This access can be obtained through a conduct-of-operations page or summary page presenting a set of pieces of mechanical and/or electrical information on a power generator. It is obtained by applying tactile pressure on the zone of the touch-sensitive screen where one of the pieces of information is displayed or tactile pressure on a particular button presented on the touch-sensitive screen. A different color can also be used to represent a magnitude depending on whether it is below or above a threshold value.

### 3.3 Notion of Acting Parties' Profiles and Associated Rights.

The handling of power generators brings into play voltage sources carried to dangerous potentials for the human body. It is therefore important that special attention be paid to the qualification of acting parties.

In certain embodiments of the invention, different profiles are distinguished and confer different rights of action on the control device. According to the invention, only the commands authorized according to the working context of the power generator, and especially the acting party's profile, are accessible.

For example, the “START” command to turn on a power generator can be accessible only to acting parties having a certain profile.

In the embodiment presented, an acting party is considered by default to have a “User” profile. This is especially the case when there is no identification of an acting party.

The “User” profile can for example enable a person to monitor the efficient functioning of a power generator and/or the power plant, especially by interpreting the electrical and mechanical information provided in real time in the different view pages.

In certain embodiments, a “User” can also make certain controls/commands on one or more parameters that do not influence the working of the power generator.

The other profiles require identification of the acting party. Certain commands are accessible only to certain profiles. For example, as illustrated in FIG. 2A, when the acting party has only a “User” profile, the “START” command is not proposed to him.

In the embodiment illustrated, an “Operator” profile is assigned to certain particular “Users”, upon identification (for example through the entry of a password). It authorizes the identified acting party to modify one or more parameters affecting the operational setting of a power generator or a power plant, and especially to change certain modes of working of a power generator.

At least one “Specialist” profile having more extensive rights of action can also be defined. In particular, in certain embodiments, only a “Specialist” is permitted to put a power generator and/or a power plant into service (therefore to power it on).

In certain embodiments, an acting party can return to a lower qualification level, for example through the cancellation of his identification, especially for the sake of security, if he thinks that he no longer has to perform the operation requiring a higher level of qualification.

### Particular Case of Temporary Qualification.

In certain embodiments, it is planned to be able to exceptionally assign an acting party a more extensive authorization to act, especially because this acting party acts under the control of a qualified third party, for example staff from a remote support service and/or because there is a necessity of urgent action.

In such embodiments, a password can be transmitted preliminarily to the control device, at the request of the qualified third party or periodically (for example daily). This password is also given to the acting party, who can thus enter it and benefit from the associated exceptional authorization to act.

### Connection Time.

In certain embodiments, the time of connection to the control device can be limited and can vary according to the acting party's profile. For example, a maximum connection time of 2 hours can be assigned to a “User”, a maximum connection time of 5 hours can be assigned to an “Operator”, and a maximum connection time of 10 hours can be assigned to a “Specialist”.

The maximum connection time can especially be displayed on the descriptive screen band of the touch-sensitive screen during an identification of an acting party. The remaining connection time can also be displayed on the touch-sensitive screen (for example on the descriptive screen band) permanently or on certain particular view pages, especially a symbol page or command pages.

### 3.4 Programming.

In certain embodiments, it is possible to command the working of a control device in several control modes, especially a “programming” mode and a “run” mode in which the configurations defined are used by the control device to control at least one power generator. The transition from one mode to another or the access to one of these control modes can, in particular, be password-protected.

The “programming” control mode can especially be used during the installation of the device. In certain embodiments, it can also be used subsequently while the device is operational, for example when the power generator is in “not-in-service” mode or “automatic” working mode to modify a view page.

When the device is in “Programming” control mode, the method can thus comprise a step for programming graphic objects, representing elements to be viewed and, as the case may be, to be animated. This programming step can especially include a step for customizing and/or animating graphic objects.

The significance of these graphic objects can for example be defined by a standard programming language for programmable automatons, for example a language recommended by the IEC 61131-3 industrial standard of the International Electrotechnical Commission (IEC) such as a “Ladder” diagram, an instructions list (IL), a structured text (ST), functional block diagrams (FBD), a sequential function chart (SFC).

In certain particular embodiments, the method can comprise a preliminary step for downloading graphic objects as well as their possible transcoding into source code files written for example in C language. These graphic objects are then controlled by the man/machine interface module while the source code files are transmitted to the base module to generate executable libraries. These executable libraries are then used by the processor of the base module when the control device is in control mode (for example “Run” mode) to send dynamic information, obtained from the input/output modules and enabling the graphic objects to be animated dynamically, to the processor of the man/machine interface module.

In other embodiments, the method can comprise a step of definition, by an acting party, of these graphic objects from the man/machine interface module of the control device.

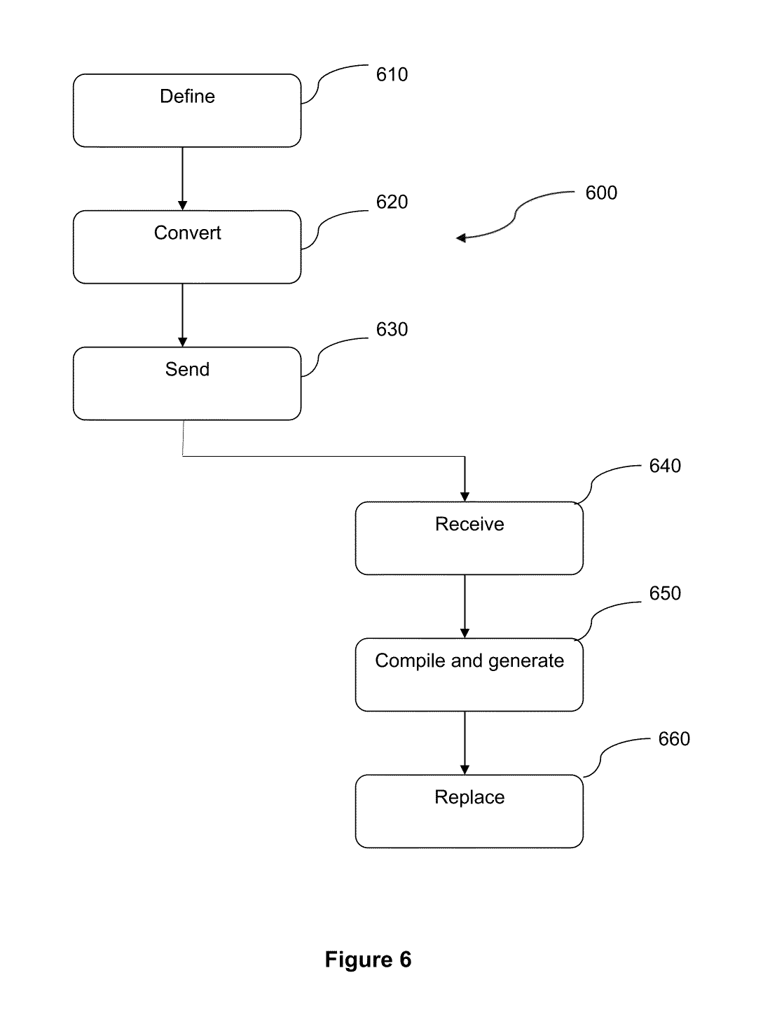

FIG. 6 thus illustrates the programming step 600 of the method of the invention in one particular embodiment in which the device is in “programming” control mode and where the graphic objects are defined from the man/machine interface module of the control device.

In the embodiment illustrated, the method thus comprises a sub-step 610 for defining graphic objects. This sub-step 610 can especially comprise the management of the display of the graphic objects, especially the integration of an image (such as a drawing of a button) or the definition of the rendering parameters, and the management of the meaning of the graphic objects, for example the indication of the element or elements that they represent, and associated logic variables.

This sub-step can also include a management of elements of consistency.

Depending on the embodiments of the invention, this management of elements of consistency can especially include a verification of compliance with naming rules and/or a grammar, a verification of compliance with elements dictated by a standard, a verification of membership of at least one used variable in a predefined list of variables, for example a list of variables provided by the manufacturer of the device, a verification of at least certain parameters of customization of logic blocks, especially the verification of at least one piece of information present in an entry zone, for example the entry of a compulsory piece of information, etc. Inconsistencies especially can be signaled by specific colors.

Thus, in the embodiment presented, this sub-step relies especially on certain aspects of the IEC 61131 standard.

For example, the rules for naming variables, especially the rules set forth by the IEC61131-3 standard, can be applied.

Thus, the name of a variable can follow the format: % L₁ L₂ N₁ N₂ N₃, where:

the prefix “%” is obligatory;

L₁ represents one of the letters I, Q or M, which respectively indicate a physical input variable, a physical output variable and a memory location;

L₂ is operational and represents one of the letters X, B, W or D, these letters respectively indicating a Boolean value, a byte, a 16-bit signed integer or a 32-bit signed integer;

N₁, N₂, and N₃ represent numbers respectively enabling designation of a module or particular bus, a card and an input.

Furthermore, a “table of variables” can be defined to contain all the names of variables that can be used for the programming so that an acting party defining a graphic object does not need to refer to documentation on the device or the IEC 61131 standard, and so as to facilitate subsequent diagnostics.

In the embodiment presented, this sub-step also relies on basic elements of the “Ladder” language and on constructions of customized function blocks of the IEC 61131 standard, especially standard bistable function blocks, such as bistable reset dominant (or “Bistable RS”) blocks and or bistable set dominant (“Bistable SR”) blocks, counters, such as up-counters or down-counters, timers such as pulse timers (PT), on-delay timers (TON or T-0), off-delay timers (TOFF or 0-T). Operators of the IEC 61131 standard such as arithmetic operators or selection functions, for example the SEL (binary selection) function and comparison operators can also be implemented.

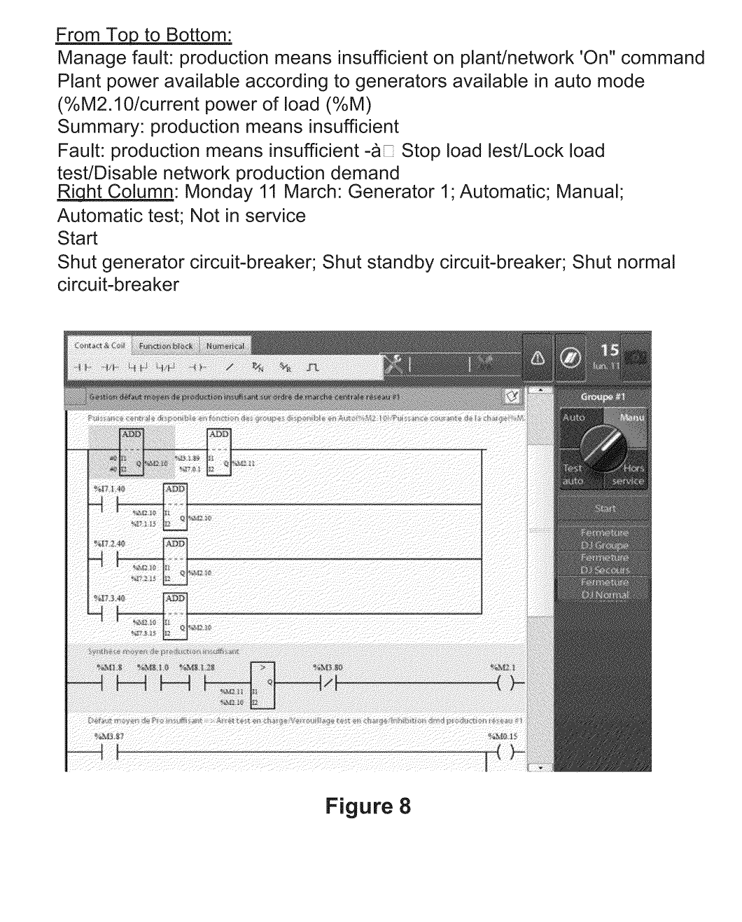

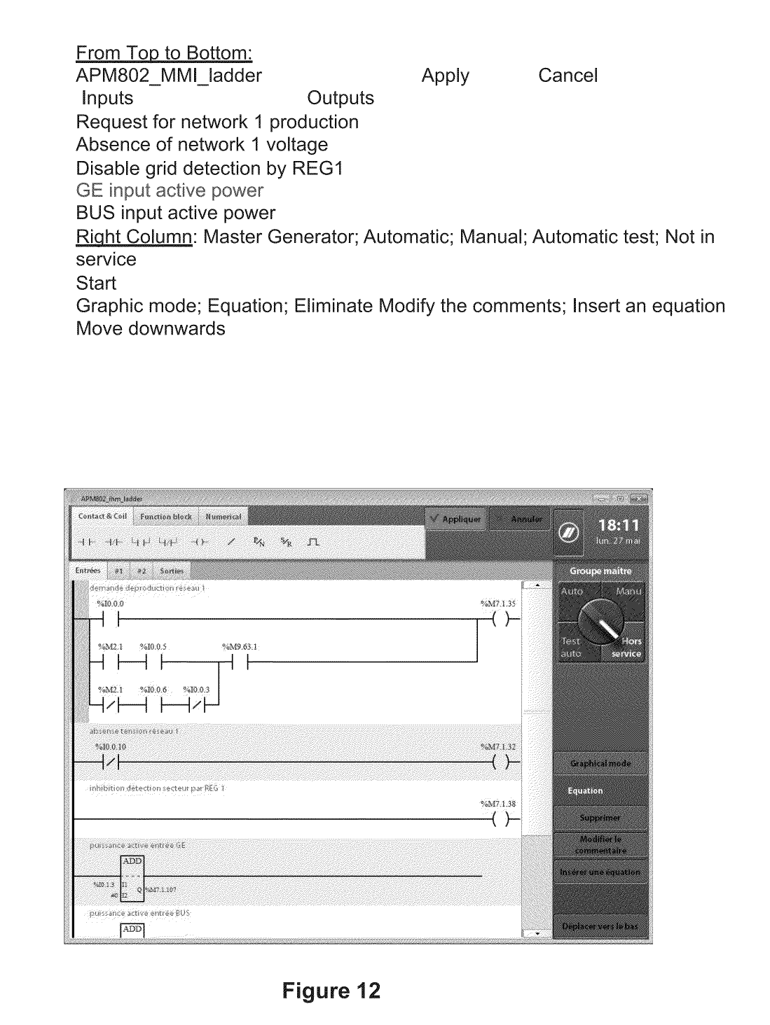

This may be a graphic definition of elements, as shown in FIG. 8. In this case, specific adaptations to the use of a touch-sensitive screen are implemented. For example, as illustrated in FIG. 12, to cope with the absence of mouse devices (and therefore the selection and/or designation by right-hand clicks), an automatic shaping of possible selections is dynamically displayed on the screen, for example in a part without representation or in a corner of the touch-sensitive screen. It is also possible to thus select a graphic view or a screen.

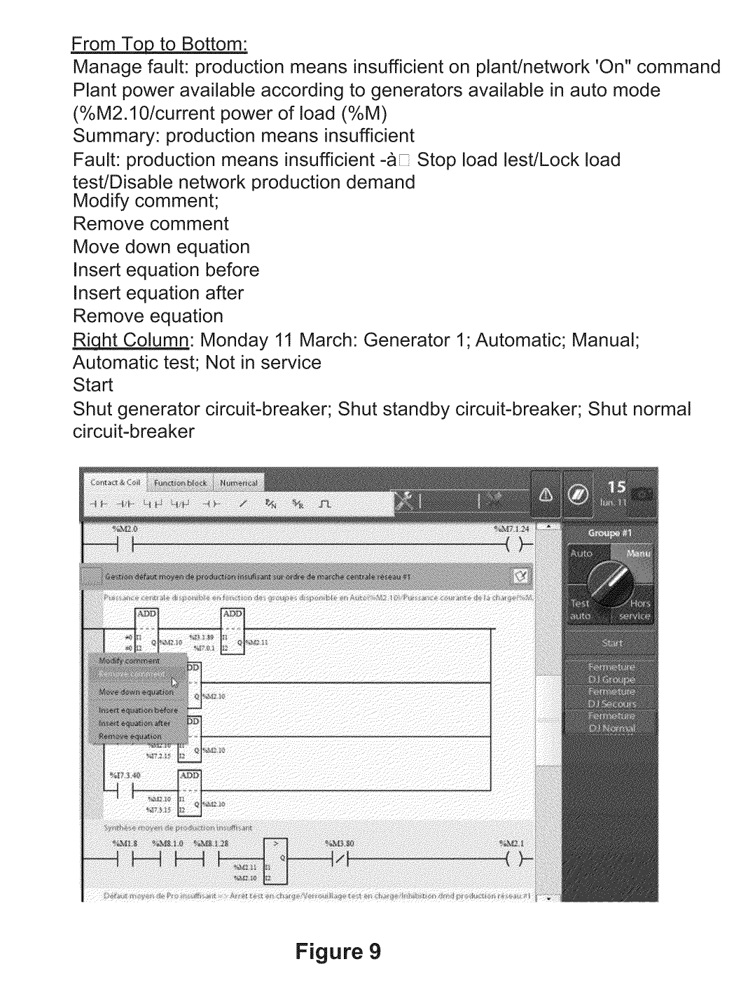

It can also be possible to compensate for the absence of a mouse by applying lengthy pressure on the touch-sensitive zone associated with an element, which can enable access to a dynamic customizing menu as shown in FIG. 9.

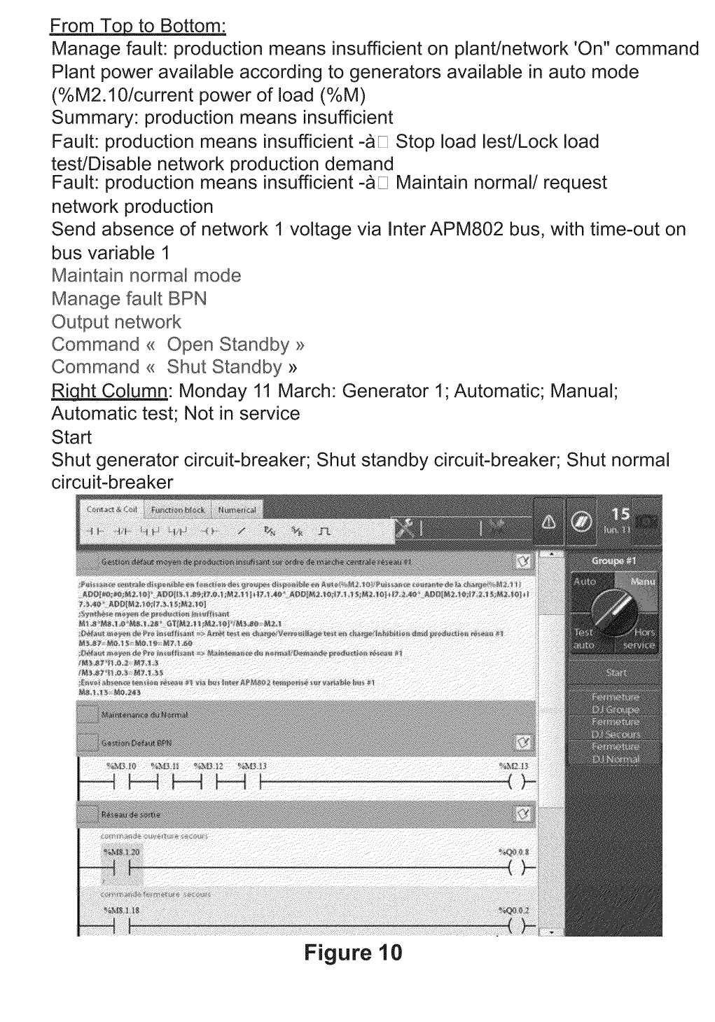

A voice interface can also be proposed to enable, for example, dictation by telephone (when the programming is done by a remote acting party especially). FIG. 10 illustrates an entry operation of this kind. In the same way, voice synthesis means can be planned for reading (more specifically for intelligibly transcribing) the current program and enabling a remote acting party to know about it.

In the embodiment presented, the programming step 600 also comprises a conversion sub-step for converting 610 graphic objects defined in source code understandable by the base module of the control device. In the embodiment presented, the graphic objects are thus converted into C language which is the language of the processor of the base module.

The programming step also comprises a sending sub-step 630 for sending the files obtained to the processor of the base module. In the embodiment illustrated, this sub-step comprises an encryption and a compression of files prior to their dispatch.

In the embodiment presented, the step 610 for defining graphic objects, step 620 for converting these objects into C code files and step 630 for sending these C code files are implemented by the man/machine interface module. In other embodiments, possibly complementary embodiments, the man/machine interface module can also include means for downloading or acquiring (for example from a detachable storage support such as a USB stick or an external hard disk drive) graphic objects which are then converted during the conversion step 620 and sent, during the sending step 630, to the base module.

In yet other embodiments, the step 610 for defining graphic objects, step 620 for converting these objects into C code files and step 630 for sending these C files can be implemented by other devices, for example a computer.

The programming step 600 also has other sub-steps which, in the embodiment illustrated, are implemented by the processor of the base module.

Thus, the programming step 600 comprises a sub-step 640 for receiving C files associated with the graphic object, possibly comprising their decompression and their decryption, a sub-step 650 for compiling received files and possibly other files already present in the base module (for example files associated with other graphic objects using certain of the files received) and for generating a new executable library from these files.

Finally, the programming step comprises a sub-step 660 for replacing the library formerly used in the control mode (for example a “Run” mode) by the new library generated.

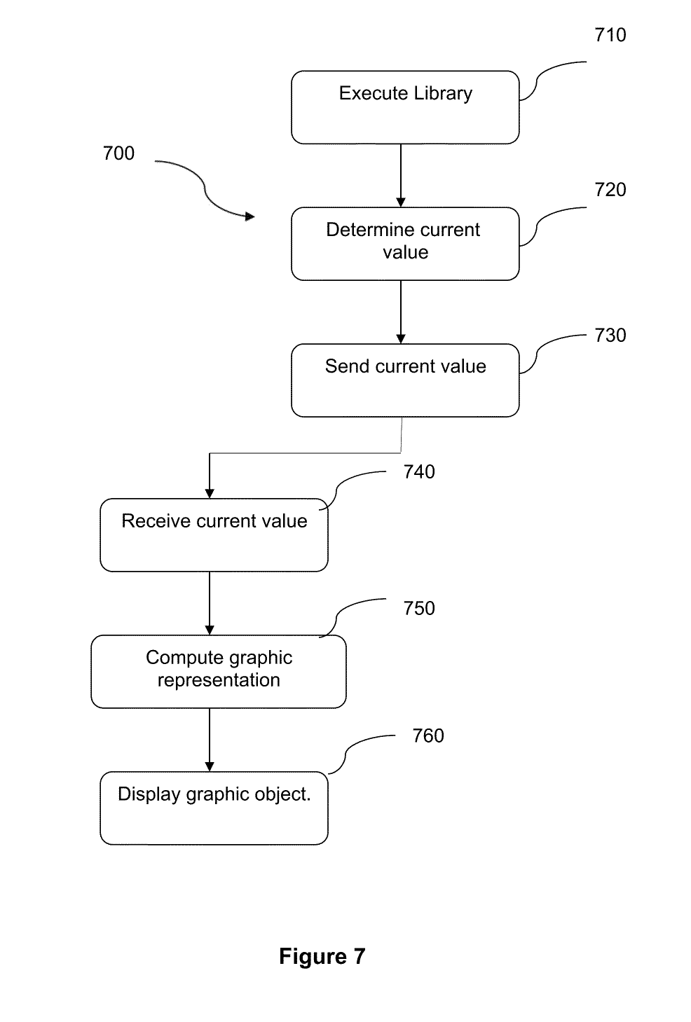

FIG. 7 thus illustrates the step 700 for animating graphic objects, in a particular embodiment in which the device is in control mode (for example a “Run” mode) and where the graphic objects have been defined from the man/machine interface module of the control device during the step 600 described here above for example.

In the embodiment illustrated, the animating step 700 thus comprises a sub-step 710 for executing the executable library. This sub-step 710 can include the reception of data coming from the input modules (especially logic and analog input/output modules and temperature inputs) and the sending of data towards the logic and analog input/output modules.

In the embodiment presented, the animating step 700 also comprises a sub-step 720 for determining the current value of at least one variable associated with a graphic object and sub-step 730 for sending this current value to the man/machine interface module. In certain embodiments of the invention, the current value of each variable of a graphic object, or of each variable whose value has changed, is transmitted periodically to the man/machine interface module. In other embodiments, the re-computed and/or modified current values are sent towards the man/machine interface module as and when data is received from the input modules.

In the embodiment presented, the step 710 of execution, step 720 for determining and step 730 for sending the current value are implemented by the base module.

The animating step 700 also comprises other sub-steps which, in the embodiment illustrated, are implemented by the processor of the man/machine interface module.

Thus, the animating step 700 comprises a sub-step 740 for receiving the current value of at least one variable of a graphic object. It also comprises a sub-step 750 for computing the representation of a graphic object. In the particular embodiment illustrated, what has to be done especially is to determine the colors and animating of the rendering of the graphic object. This sub-step comprises especially a computation of the color code associated with each logic variable in order to facilitate diagnostics by an acting party as indicated here above.

Finally, the animating step 700 comprises a sub-step 760 for displaying the graphic object.

### 4 Working Modes, States of Operation and Transitions

### 4.1 Working Modes.

In the embodiment illustrated in FIGS. 2A to 2E, 4B and 5C, a selector is used to define the working mode of the control device from among the “Not in service”, “Manual”, “Auto” and “Auto Test” modes.

Depending on the embodiments of the invention, it is possible that certain modes cannot be implemented. For example the “Not in service” mode cannot be used for a “Common Part” type of apparatus of a power plant.

### “not in Service” Working Mode.

The “Not in service” working mode is the security mode of the method of control. In this mode, the control device is locked and no start is possible whether it is by a local command or a remote command. In certain embodiments, the view pages are however accessible. The alarms or the working faults can also be provided.

This mode is the default mode of the control device of a power generator, during the powering on of the power generator. This is also the mode used during operations of maintenance of the power generator, or when the generator is stopped in the presence of a fault.

In the embodiment presented, any passage into the “Not in service” mode triggers a command for the immediate emergency stoppage of the engine of the power generator.

### “Manual” Working Mode.

In the “Manual” working mode, the actions on the power generator can only be done manually, i.e. by the action of an acting party on the touch-sensitive screen, locally or remotely. It can for example be the actuation of the “START” command, the command of a cut-off and protection unit, for example a circuit-breaker, commands pertaining to a synchronization, a coupling and/or load distribution.

### “Auto” Working Mode.

In the “Auto” working mode, the actions on the power generator are done only automatically or remotely. For example, the “START” command can be activated automatically, following the detection of a power cut in the power grid or following an external order. Commands relating to synchronization, coupling and/or load distribution can also be actuated automatically.

### “Auto Test” Working Mode.

The “Auto Test” working mode is used to periodically check that the power generator or the power plant is working well.

In the “Auto Test” working mode, the synchronization, coupling and distribution of load are automatic. The stopping of the power generator can be done automatically or manually.

Depending on the embodiments of the invention, the “Auto Test” mode of operation can enable the performance of various tests, especially off-load tests or load tests.

The off-load tests can include an automatic starting of the power generator with a build-up of speed and/or voltage and/or stabilization (a circuit-breaker/alternator being deactivated) and/or a programmed automatic halt.

The load tests can include an automatic starting up of the power generator with a build-up in speed and/or voltage and/or stabilization, an alternator/circuit-breaker being activated, phases of synchronization, coupling and/or load distribution and/or load transfer depending on the configuration of the power generator (power plant coupling and/or coupling to network) and/or a programmed automatic stop.

In the present embodiment, three additional keys (“Off-load test”, “Load test”, “End of test”) can for example be proposed after selection of the “Auto Test” mode.

The “Auto Test” working mode is a particular case of the “Auto” working mode with a running of automatic tests. In the embodiment illustrated, the selection of the “Auto Test” working mode therefore also activates the selection of the “Auto” working mode. After the end of the tests (or the activation of the “end of Test” key), the working mode of the control device can be automatically switched into the “Auto” mode.

Depending on the implantation of the control device (in a power generator or in a Common Part), it can be the case that the activation of the “off-load test” or of the “load test” is not possible.

For example, in the case of power generators configured as a power plant, without coupling to the network and without normal/emergency inverter, with an active and reactive power distribution by digital buses, when the mode selected is a mode of coupling when stopped, a “off-load test” choice is not accessible on a Man/Machine Interface of the power generator, the load being directly connected to the set of busbars downstream from the power generators.

### 4.2 Working States of a Power Generator.

In addition to the working modes described here above, it is necessary to distinguish the different working states for a power generator. Thus, in the embodiment illustrated, a power generator can be “at a halt”, on standby, in production (“On”) or again in an unavailable state, for example owing to a loss of network connection between a Common Part and a distant power generator, or again it can be “faulty”.

For example, a power generator can have “Auto” as its working mode and be in a “standby” working state.

### 4.3 Management of Events and Transition Between States.

Here below, a more detailed illustration is provided of the steps of the method of the invention during certain particular events.

Putting a Power Generator into Service.

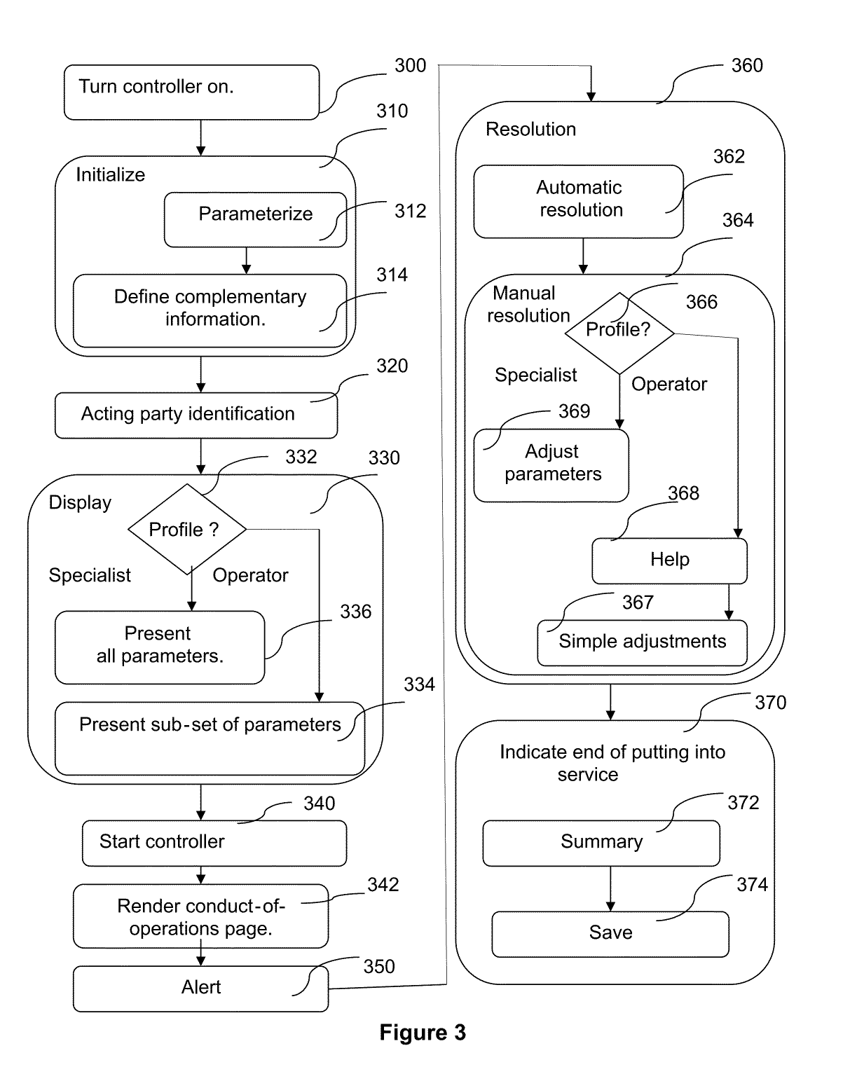

FIG. 3 illustrates the working of the method of control of the invention, in one particular embodiment, when a power generator is put into service, for example during the first activation of the control device, after the installation of the power generator and the setting up of the main connections.

This event thus prompts the transition of the working state of the power generator from “stop” to a “standby” or “production” (“On”) working state for example.

In the embodiment illustrated, the method thus comprises a step 300 for turning on the control device (or controller). This step can be followed by a step of initialization 310 comprising especially a sub-step 312 for the parameterizing of the device, for example the language to be used and the current date and time as well as a sub-step 314 for defining complementary information, which can be entered for example by hand or obtained by a USB stick. This can be information on the customer who has acquired the power generator (for example a logo to be shown on the touch-sensitive screen) and/or the power generator itself (for example a naming of the power generator and/or the power plant). In the embodiment illustrated, the method then comprises a step 320 for identifying the acting party acting on the device and a step 330 for displaying the default parameters of the power plant.

Depending on the acting party's profile, this display can be different.

Thus, in the embodiment illustrated, the display step 330 comprises a sub-step 332 for testing the acting party's profile. If the acting party is a “Specialist”, all the factory-defined and modifiable parameters are displayed (step 336 for displaying all the modifiable factory parameters). If the acting party has a lower-powered profile, for example an “Operator” profile, only a simplified sub-set of these parameters is presented (step 334 for displaying the set of certain modifiable factory parameters).

In the embodiment illustrated, the method then comprises a step 340 for starting the control device which leads to a step 342 for rendering a conduct-of-operations page or utilization page which represents the home page when the device is idle. As and when pieces of data are acquired by the different modules of the control device, alarms and faults appear and are presented in cascade on the conduct-of-operations page during the alert step 350.

In the embodiment presented, the method then comprises a step 360 for resolving faults that have appeared. Certain faults are resolved automatically by the device (step 362). Other faults must be resolved manually by the acting party (step 364).

In the embodiment presented, the manual resolving 364 of the faults that have appeared comprises a sub-step 336 for verifying the acting party's profile. If the acting party is a “Specialist”, the method can comprise a sub-step 369 for adjusting the operational parameters of the power generator. If he is an “Operator”, the method can comprise an optional sub-step 368 for requesting assistance, followed or preceded by a sub-step 367 for implementing simplified adjustments. This sub-step can especially necessitate the preliminary entry of a specific temporary authorization password.

In the embodiment illustrated, the method then comprises a step 370 for indicating an end of the operation for putting into service. During this step 370, it can be verified especially that all the faults that appeared have been corrected. This step 370 can comprise, in particular, a sub-step 372 for summarizing the modifications made. It can also include a saving 374 of the parameters of the power generator, for example in a memory of the power generator and/or in a database or again in a detachable medium such as a USB stick, a CD-ROM or an external hard disk drive for example, or again a paper medium. In particular, it can be a customer information sheet which will be transmitted to the manufacturer of the power generator or to a customer support service.

Finally, the end of the operation for putting the power generator into service is followed by a step for rendering the conduct-of-operations page.

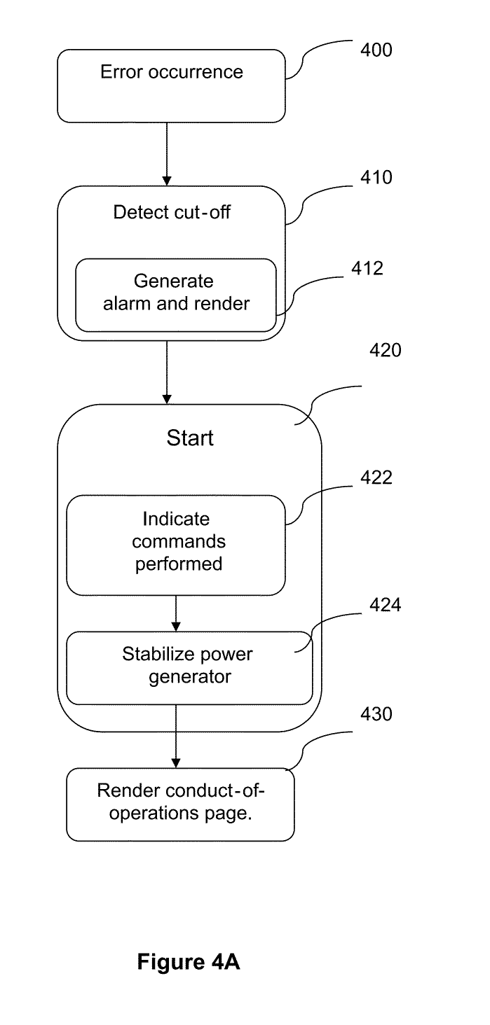

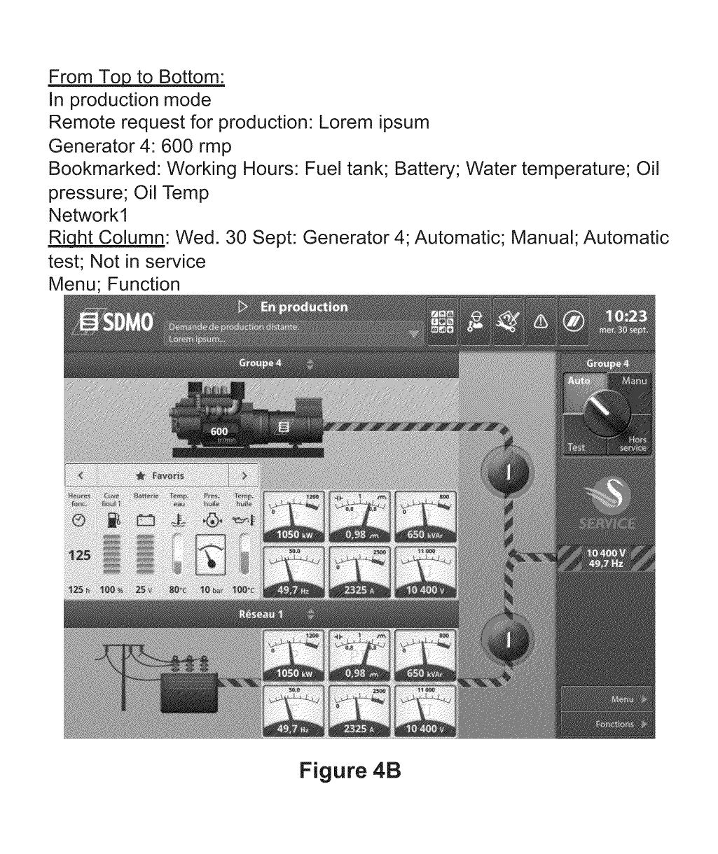

Starting the power generator in the event of a power-grid cut-off. FIG. 4A illustrates the working of the method of control of the invention, in one particular embodiment, when there is a power grid cut-off 400 at a place protected by a power generator in “standby” working state while this power generator is in “Auto” mode. This power grid cut-off thus prompts the transition from the “standby” working state of the power generator to the “production” state.

The method of control of the invention comprises a step 410 for detecting the power grid cut-off. In the embodiment illustrated, this step comprises a sub-step for generating an alarm 410 and for rendering the power grid cut-off on the “network zone” of the conduct-of-operations page.

The method of control of the invention also comprises a step 420 for starting the power generator. In the embodiment illustrated, this step 420 especially comprises a sub-step 422 for indicating the different commands performed automatically on the power generator, especially: starting the power generator (“START” command), build-up of engine speed, a synchronization, coupling, a load ramp and/or a distribution. This sub-step makes it possible especially for a local or distant acting party to follow the progress of the starting of the power generator on the touch-sensitive screen. In particular, a particular menu can be displayed, for example the menu illustrated in FIG. 4A, giving access to the information on the command in progress.

In the embodiment illustrated, the starting step 420 additionally comprises a sub-step 424 for stabilizing the power generator, comprising especially the closure of the power unit and the supply of the local network.

In the embodiment illustrated, the method of control of the invention also comprises a step 434 for rendering the conduct-of-operations page, presenting values of certain of the parameters of the power generator, especially electrical parameters, and the “production” working state of the power generator. It can be for example the conduct-of-operations page illustrated in FIG. 4B.

### 4.4 Management of Alarms.

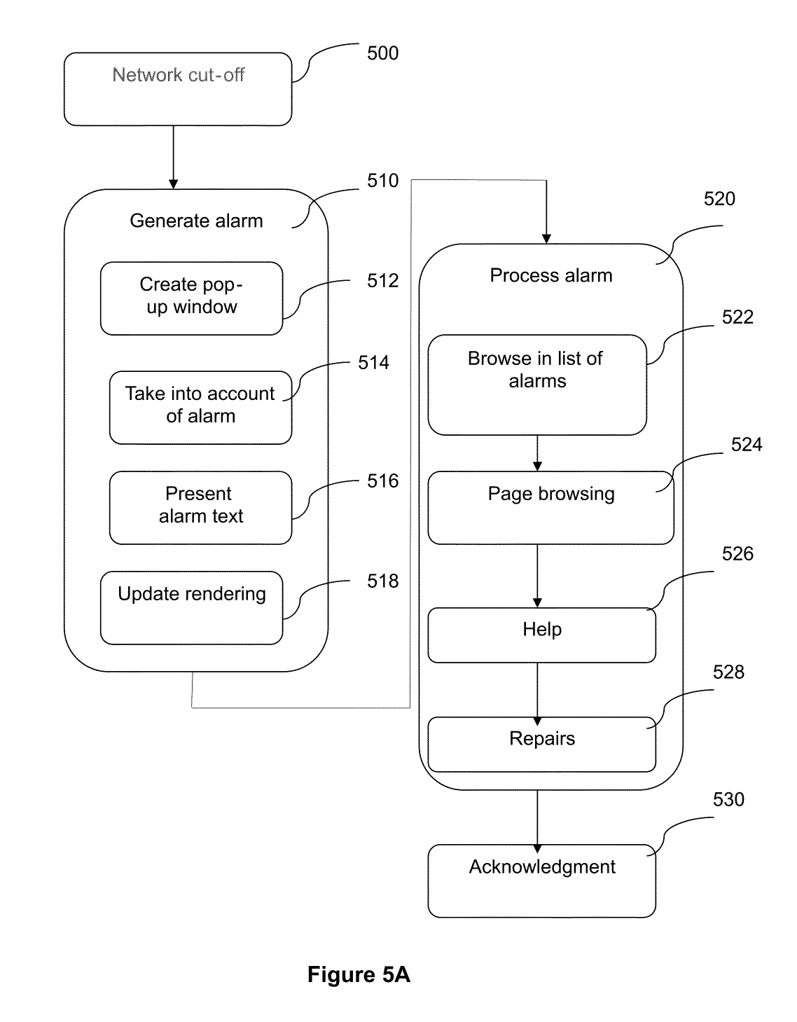

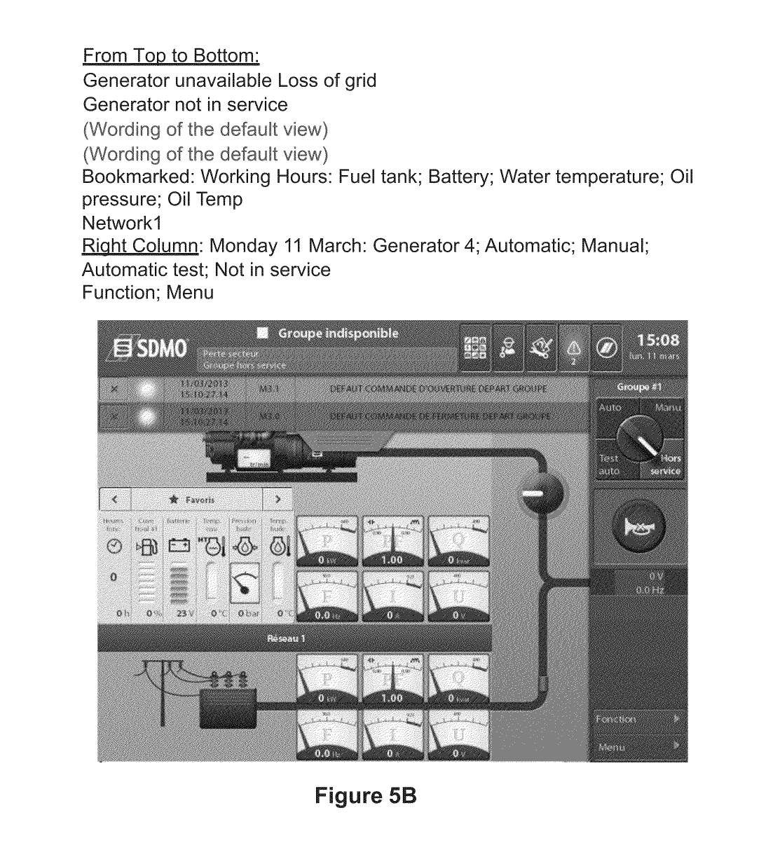

FIG. 5A illustrates the working of the method of control of the invention, in one particular embodiment, during the occurrence 500 of an alarm, relating for example to a fault occurring on a power generator in the “standby” state for example, while this power generator is in “Auto” mode. It can for example be an alarm pertaining to a water temperature or to an oil pressure fault.

Depending on the nature of the alarm, this event prompts, for example, the transition of the power generator from its “standby” working state to the “fault” working state.

The method of control comprises a step 510 for generating an alarm. This step can, in particular, comprise the generation of visual, textual and/or sound indications. In particular, it can be related to the activation of a siren, and or an appearance of a pad representing a sound alarm, a generation of a pop-up window, a flashing animation of a faulty element and/or an error coder.

The indications may depend especially on a level of criticality assigned to an alarm. For example, in the embodiment illustrated, when the alarm has a high level of criticality, the step for generating 510 can include the creation 512 of a pop-up window and/or the turning on of a siren. A text on the alarm can also be presented (step 516) on at least one zone of the page, for example in the embodiment presented, by a colored information line in and/or beneath the upper screen band of the page.

FIGS. 4B and 5B thus illustrate a conduct-of-operations page of a power generator in production, before and after the appearance of a fault.

The method can also comprise a validation 514 of the taking into account of the general alarm, for example by the clicking of an “OK” button presented on the pop-up window generated and/or by the extinguishing of a sound alarm.

In the embodiment illustrated the step for generating 510 also comprises a sub-step (not shown) for adding the alarm to a list of alarms to be processed. In addition, when the alarm is linked to the detection of a fault or a change in state of a parameter or an apparatus, the method also comprises a step 518 for updating the corresponding rendering on the view pages and especially a visual indication (for example by a red coloring) of that part of the power generator to which the fault is related, on a block diagram of the power generator.

In the embodiment presented, the method also comprises a step 520 for processing the alarm generated.

In certain embodiments, the processing can be an automatic processing (for example when working in “Auto” mode, especially following a detection of network loss). This processing step can also be performed manually by an acting party, working on the power generator concerned or at a distance (especially by an acting party working from the Common Part of a power plant or from a tablet or a personal computer comprising means of communication with the control device). It can include for example a sub-step 522 for browsing in the list of alarms to be processed and/or a sub-step 524 for browsing in the view pages of the device, especially in the page highlighting the fault (for example by clicking on a part of the power generator concerned by a fault, so as to view all the faults relating to this part of the power generator).

In certain particular embodiments, the processing step 520 can also include a sub-step of help 526 for the acting party. Depending on the embodiments, the step can be implemented at the acting party's request, or routinely, or depending on the level of criticality or complexity of the alarm, or again after the completion of a certain time-out period without the alarm having been processed. Minimum help can also be proposed to the acting party who can then, at request, obtain a more complete level of help.

Depending on the embodiments, this system can for example consist of the display of a pop-up help window comprising, for example, explanations, recommendations, an error code and/or a hotline number to be contacted, an indication of access to an online tutorial and/or a hotline service, synchronously (by a telephone call for example) or asynchronously (by email or fax). Finally, the processing step 520 can include a sub-step 528 for repairs, when there is a fault that can be eliminated, for example by means of a command to the power generator, a modification of at least one parameter, or by a replacement of at least one mechanical or electrical part. The view pages give real-time reports of the repairs.

Depending on the embodiments, this sub-step can be performed during or after the help sub-step 526, locally, for example by the acting party, possibly using a temporary code giving access to a profile possessing greater possibilities of action than his own profile, or remotely, by an authorized third-party.

In certain embodiments, the processing step 520 can be implemented at the same time as the alarm-generating step 510, for example because the critical nature of the alarm requires priority processing, as in the case when it dictates an emergency stoppage of the power generator.

The method can also include a step 530 for acknowledging the alarm. In the embodiments, this step can be performed automatically by the system, when the cause of the alarm has disappeared. In other embodiments, possibly complementary embodiments, the acknowledgement is done manually by the acting party. Thus, in the embodiment illustrated, each alarm must be acknowledged manually, even when it is has been processed and/or when the fault possibly associated with the alarm has disappeared.

The acknowledgement of the alarm causes the alarm to disappear from the list of alarms to be processed, along with its indication on the touch-sensitive screen.

Certain embodiments of the invention implement the preservation of and access to a timeline of the alarms that have appeared.

In other embodiments, which are possibly complementary embodiments, the method can include a preliminary step for the configuring of certain parameters relating to the generation, processing or acknowledgement of an alarm (especially the definition of the help and/or alerting means used, a time-out before an activation of an alarm, in the event of the appearance of an anomaly, variables to be monitored, and associated threshold values generating an alarm etc.).

What is claimed is:

1. A method for controlling at least one power generator, the method comprising:
selectively displaying on a touch-sensitive screen a set of command buttons available at a given point in time,
determining a working context and selecting a set of command buttons available for said working context;
displaying said set of available command buttons on said touch-sensitive screen;
detecting an activation of one of the available command buttons, called an activated command button; and
performing at least one action associated with said activated command button.

2. The method according to claim 1, further comprising:
managing a selector displayed on said screen enabling the selection of a mode of working of said at least one power generator from among at least the following four modes:
not-in-service mode,
manual working mode,
automatic working mode, and
test working mode; and
managing an on/off switch displayed on said screen, said on/off switch being active in the manual working mode and proposing an “On” possibility if said at least one power generator is off and proposing an “Off” possibility if said at least one power generator is on.

3. The method according to claim 1, wherein detecting the activation of one of the available command buttons comprises:
detecting a touch-sensitive contact on a zone of said touch-sensitive screen on which one of said command buttons is displayed, and, in response:
performing no action associated with said command button when the touch-sensitive contact is shifted outside said zone by means of a sliding movement on a surface of the screen;
initiating a time-out for a predetermined duration when the touch-sensitive contact is released;
performing no action associated with said command button when a new touch-sensitive contact occurs before an end of said time-out;
performing the at least one action associated with said command button when no new touch-sensitive contact occurs before the end of said time-out.

4. The method according to claim 1, further comprising displaying on said touch-sensitive screen:
at least one summary page presenting at least one selected from a group of mechanical and electrical information on the at least one power generator in an illustration;
at least one detailed page, accessible from said at least one summary page, by touch pressure on a zone of the touch-sensitive screen bearing the illustration associated with the information for which a summary is provided;
at least one timeline page displaying at least one curve of an evolution in time of a magnitude of a value relative to a piece of the information; and
at least one predetermined pressure zone on said touch-sensitive screen enabling a return to a previous page at each instant.

5. The method according to claim 1, wherein the set of commands includes at least one selected from a group of a video capture command and a screen capture command, and wherein performing the at least one action includes at least one selected from a group of transmitting said capture on an external data carrier and storing said capture on an external data carrier.

6. The method according to claim 1, further comprising programming the electrical behavior of said at least one power generator.

7. The method according to claim 6, wherein programming the electrical behavior includes graphically representing an electrical network comprising the at least one power generator, which is modifiable through said touch-sensitive screen.

8. The method according to claim 6, wherein programming the electrical behavior comprises a step of compilation and a step of execution of a program performed by an acting party, said steps of compilation and execution being carried out by a same control unit.

9. A device for controlling at least one power generator, the device comprising:
a touch-sensitive screen on which there selectively appears a set of command buttons available at a given point in time, and
means for driving said touch-sensitive screen, the means for driving comprising:
means for determining a working context and selecting a set of command buttons available for said working context;
means for controlling a display on said touch-sensitive screen of said set of available command buttons;
means for detecting an activation of one of said available command buttons, called an activated command button;
means for launching at least one action associated with said activated command button.

10. The device of claim 9, further comprising:
modes of working the at least one power generator displayed on the screen including at least the following four modes:
not-in-service mode,
manual working mode,
automatic working mode, and
test working mode;
a selector displayed on the screen enabling the selection of one of the modes of; and
an on/off switch displayed on the screen in the manual working mode, the on/off switch proposing an “On” possibility when the at least one power generator is off and proposing an “Off” possibility when the at least one power generator is on.

11. The device of claim 9, further comprising:
a summary page, displayed on the screen, presenting at least one selected from a group of mechanical and electrical information of at least one power generator in an illustration;
a detailed page, accessible from the summary page by touch pressure on a zone of the touch-sensitive screen bearing the illustration associated with the information for which a summary is provided; and
a timeline page displaying at least one curve of an evolution in time of a magnitude of a value related to the information.

12. The device of claim 9, wherein the set of commands includes at least one selected from a group of a video capture command and a screen capture command, wherein the at least one power generator is communicatively coupled to an external data carrier, and wherein performing the at least one action includes at least one selected from a group of transmitting and storing the capture on the external data carrier.

13. The device of claim 9, further comprising a graphical representation of an electrical network on the screen.

14. The device of claim 9, further comprising a programming interface displayed on the screen enabling programming of the at least one power generator.

15. A power generator comprising:
a control device comprising a touch-sensitive screen on which there selectively appears a set of command buttons available at a given point in time; and
means for driving said touch-sensitive screen, the means for driving comprising:
means for determining a working context and selecting a set of available command buttons for said working context;
means for controlling a display on said touch-sensitive screen of said set of available command buttons;
means for detecting an activation of one of said available command buttons, called an activated command button;
means for launching at least one action associated with said activated command button.

16. The power generator of claim 15, further comprising:
modes of working the power generator displayed on the screen including at least the following four modes:
not-in-service mode,
manual working mode,
automatic working mode, and
test working mode;
a selector displayed on the screen enabling the selection of one of the modes of; and
an on/off switch displayed on the screen in the manual working mode, the on/off switch proposing an “On” possibility when the power generator is off and proposing an “Off” possibility when the power generator is on.

17. The power generator of claim 15, further comprising:
at least one summary page, displayed on the screen, presenting at least one selected from a group of mechanical and electrical information of power generator in an illustration;
at least one detailed page, accessible from the summary page by touch pressure on a zone of the touch-sensitive screen bearing the illustration associated with the information for which a summary is provided; and
at least one timeline page displaying at least one curve of an evolution in time of a magnitude of a value related to the information.

18. The power generator of claim 15, wherein the set of commands includes at least one selected from a group of a video capture command and a screen capture command, wherein the power generator is communicatively coupled to an external data carrier, and wherein performing the at least one action includes at least one selected from a group of transmitting and storing the capture on an external data carrier.

19. The power generator of claim 15, further comprising a graphical representation of an electrical network on the screen.

20. The power generator of claim 15, further comprising a programming interface displayed on the screen enabling programming of the power generator.
